(19) United States
(12) Patent Application Publication
(10) Pub. No.: US 2024/0387127 A1
(43) Pub. Date: Nov. 21, 2024

(54) Electrical Circuit Breaker Device

(71) Applicant: PACIFIC ENGINEERING CORPORATION, Gifu (JP)

(72) Inventors: Naoki Yamamura, Gifu (JP); Akihiko Shimizu, Gifu (JP)

(73) Assignee: PACIFIC ENGINEERING CORPORATION, Gifu (JP)

(21) Appl. No.: 18/693,815

(22) PCT Filed: Aug. 19, 2022
(86) PCT No.: PCT/JP2022/031283

§ 371 Date: Mar. 20, 2024

(30) Foreign Application Priority Data
Oct. 28, 2021 (JP) 2021-176147

(51) Int. Cl. H01H 39/00; H01H 37/76; H01H 85/02; H01H 85/08; H01H 85/18

(52) U.S. Cl. CPC H01H 39/006; H01H 37/761; H01H 85/0241; H01H 85/08; H01H 85/185; H01H 2231/026

(57) ABSTRACT

Provided is an electrical circuit breaker device having quick breaking capability not only to relatively high currents but also to relatively low currents. The electrical circuit breaker device includes: a to-be-cut portion (400) that is arranged in a housing (301) and constitutes a part of an electrical circuit; and a moving body that moves in the housing (301) between a first end portion (320) and a second end portion (330) on an opposite side of the first end portion (320) by a power source P, in which the electrical circuit breaker device includes a fuse functional circuit portion (800) that is connected to the to-be-cut portion (400) and has a fusion portion (740) and an arc-extinguishing material Q, the moving body includes: a first moving body (500) that moves by the power source P; and a second moving body (600) that moves by power of the first moving body (500), the first moving body (500) moves from the first end portion (320) toward the second end portion (330) and cuts off a cutting piece (420) of the to-be-cut portion (400), and the second moving body (600) cuts off a part of the fuse functional circuit portion (800) after the first moving body (500) cuts off the cutting piece (420).

### TECHNICAL FIELD

The present invention relates to an electrical circuit breaker device that can be mainly used for an electrical circuit of an automobile or the like.

### BACKGROUND ART

Conventionally, an electrical circuit breaker device has been used to protect an electrical circuit mounted on an automobile or the like and various electrical components connected to the electrical circuit. Specifically, when an abnormality occurs in the electrical circuit, the electrical circuit breaker device cuts off a part of the electrical circuit to physically break the electrical circuit.

In addition, a voltage and a current applied to an electrical circuit tend to increase due to recent improvement in performance of automobiles and the like, and it has been required to extinguish an arc generated immediately after the electrical circuit is broken by the electrical circuit breaker device more effectively, quickly and safely. Therefore, an electrical circuit breaker device according to Patent Literature 1 is an electrical circuit breaker device including a fuse, a housing, a to-be-cut portion that is arranged in the housing and constitutes a part of an electrical circuit, a power source that is arranged on a side of a first end portion of the housing, and a moving body that moves in the housing between the first end portion and a second end portion on an opposite side of the first end portion, in which the moving body is moved by the power source from the first end portion toward the second end portion, and a part of the moving body cuts off the to-be-cut portion to break the electrical circuit. A current (fault current) flowing through the electrical circuit when the electrical circuit is broken is induced to the fuse, and an arc generated by the induced current is effectively, quickly and safely extinguished in the fuse.

In addition, the current to be broken in the electrical circuit is assumed to be in a wide range, including not only relatively high currents, but also relatively low currents. Therefore, in the electrical circuit breaker device of Patent Literature 1, a case where the current (fault current) induced when the electrical circuit is broken is a relatively low current, depending on the fusing characteristics of the fuse, may include a case where the time until the fuse breaks the current may be long or a case where the current may not be broken.

### CITATIONS LIST

### Patent Literature

Patent Literature 1: Japanese Patent Application No. 2020-208249

### SUMMARY OF INVENTION

### Technical Problems

Therefore, in view of the above problems, the present invention provides an electrical circuit breaker device having a quick breaking capability in a wide current range, including not only relatively high currents, but also relatively low currents.

### SOLUTIONS TO PROBLEMS

An electrical circuit breaker device according to the present invention includes:
a housing;
a to-be-cut portion that is arranged in the housing and constitutes a part of an electrical circuit;
a power source that is arranged on a side of a first end portion of the housing; and
a moving body that moves in the housing between the first end portion and a second end portion on an opposite side of the first end portion by the power source, in which
the electrical circuit breaker device includes a fuse functional circuit portion that is connected to the to-be-cut portion and has a fusion portion and an arc-extinguishing material,
the moving body includes a first moving body that moves by the power source, and a second moving body that moves by a power of the first moving body,
the first moving body moves from the first end portion toward the second end portion by the power source, and cuts off a cutting piece positioned between base pieces on both sides of the to-be-cut portion, and
the second moving body cuts off a part of the fuse functional circuit portion after the first moving body cuts off the cutting piece.

Further, in the electrical circuit breaker device according to the present invention, an accommodating space in which the arc-extinguishing material of the fuse functional circuit portion is accommodated is a space different from an accommodating space in which the first moving body and the second moving body are movably accommodated, the fuse functional circuit portion includes a deformable connection portion that connects the fusion portion and the to-be-cut portion and is deformable, and the second moving body pushes out a part of the fuse functional circuit portion to cut off the fusion portion and deform the deformable connection portion.

Further, in the electrical circuit breaker device according to the present invention, the accommodating space in which the arc-extinguishing material of the fuse functional circuit portion is accommodated is the space different from an accommodating space in which the first moving body and the second moving body are movably accommodated, the fuse functional circuit portion includes at least two fusion portions, and the second moving body pushes out a part of the fuse functional circuit portion to break the fuse functional circuit portion.

Further, in the electrical circuit breaker device according to the present invention, the second moving body includes an accommodating space through which a part of the fuse functional circuit portion is inserted and in which the arc-extinguishing material can be accommodated, and the second moving body moves to apply a pressing force to a part of the fuse functional circuit portion through the arc-extinguishing material to cut off the part of the fuse functional circuit portion.

Further, in the electrical circuit breaker device according to the present invention, a length between cutting portions on both sides of the fuse functional circuit portion is shorter than a length between cutting portions of a cutting piece and base pieces on both sides of the to-be-cut portion, or a length between cutting portions on both sides of the fuse functional circuit portion is equal to a length between cutting portions of a cutting piece and base pieces on both sides of the to-be-cut portion.

The electrical circuit breaker device according to the present invention further includes a conversion mechanism that converts a pressing force for moving the second moving body in a first direction from the first end portion to the second end portion into a tensile force in a second direction intersecting the first direction, in which the tensile force cuts off a part of the fuse functional circuit portion.

According to each of the above features, in a case where an overcurrent belonging to a relatively low current range flows through the electrical circuit, the first moving body cuts off the cutting piece of the to-be-cut portion, and then the second moving body cuts off a part of the fuse functional circuit portion including the fusion portion, thereby preventing the overcurrent from flowing through the electrical circuit. On the other hand, in a case where an overcurrent belonging to a relatively large current range flows through the electrical circuit, when the first moving body cuts off the cutting piece of the to-be-cut portion, a fault current is induced to the fusion portion of the fuse functional circuit portion to be safely broken, thereby preventing the overcurrent from flowing through the electrical circuit.

### Advantageous Effects of Invention

As described above, according to the electrical circuit breaker device of the present invention, a quick breaking capability is provided for a wide current range, including not only relatively high currents, but also relatively low currents.

### BRIEF DESCRIPTION OF DRAWINGS

FIG. 1(a) is an overall perspective view of a lower housing constituting a housing of an electrical circuit breaker device according to a first embodiment of the present invention, FIG. 1(b) is a plan view of the lower housing, and FIG. 1(c) is a sectional view of the lower housing taken along line A-A.

FIG. 2(a) is an overall perspective view of an upper housing constituting a housing of the electrical circuit breaker device according to the first embodiment of the present invention, FIG. 2(b) is a plan view of the upper housing, and FIG. 2(c) is a sectional view of the upper housing taken along line B-B.

FIG. 3(a) is an overall perspective view of an intermediate housing constituting a housing of the electrical circuit breaker device according to the first embodiment of the present invention, FIG. 3(b) is a plan view of the intermediate housing, and FIG. 3(c) is a sectional view of the intermediate housing taken along line C-c.

FIG. 4(a) is a perspective view of a first moving body of the electrical circuit breaker device according to the first embodiment of the present invention, FIG. 4(b) is a plan view of the first moving body, FIG. 4(c) is a sectional view of the first moving body taken along line D-D, and FIG. 4(d) is a bottom view of the first moving body.

FIG. 5(a) is a perspective view of a second moving body of the electrical circuit breaker device according to the first embodiment of the present invention, FIG. 5(b) is a plan view of the second moving body, FIG. 5(c) is a sectional view of the second moving body taken along line E-E, and FIG. 5(d) is a sectional view of the second moving body taken along line F-F.

FIG. 6(a) is a perspective view of a to-be-cut portion of the electrical circuit breaker device according to the first embodiment of the present invention, and FIG. 6(b) is a sectional view of the to-be-cut portion taken along line G-G.

FIG. 7(a) is a perspective view of a circuit portion constituting a part of an electrical circuit broken by the electrical circuit breaker device according to the first embodiment of the present invention, and FIG. 7(b) is a sectional view of the circuit portion taken along line H-H.

FIG. 8 is an exploded perspective view of the electrical circuit breaker device according to the first embodiment of the present invention.

FIG. 9 is a sectional view, taken along line I-I, of the electrical circuit breaker device according to the first embodiment of the present invention in an assembled state.

FIG. 10 is a sectional view illustrating a state in which the first moving body moves from the state illustrated in FIG. 9.

FIG. 11 is a sectional view illustrating a state in which the first moving body further moves from the state illustrated in FIG. 10.

FIG. 12(a) is a perspective view of a to-be-cut portion of an electrical circuit breaker device according to a second embodiment of the present invention, and FIG. 12(b) is a sectional view of the to-be-cut portion taken along line J-J.

FIG. 13 is a sectional view of the electrical circuit breaker device according to the second embodiment in an assembled state.

FIG. 14 is a sectional view illustrating a state in which the first moving body moves from the state illustrated in FIG. 13.

FIG. 15 is a sectional view illustrating a state in which the first moving body further moves from the state illustrated in FIG. 14.

FIG. 16(a) is a perspective view of a to-be-cut portion of an electrical circuit breaker device according to a third embodiment of the present invention, and FIG. (b) is a sectional view of the to-be-cut portion taken along line K-K.

FIG. 17 is a sectional view of the electrical circuit breaker device according to the third embodiment in an assembled state.

FIG. 18 is a sectional view illustrating a state in which the first moving body moves from the state illustrated in FIG. 17.

FIG. 19 is a sectional view illustrating a state in which the first moving body further moves from the state illustrated in FIG. 18.

FIG. 20 is a sectional view of the electrical circuit breaker device according to a fourth embodiment in an assembled state.

FIG. 21 is a sectional view illustrating a state in which the first moving body moves from the state illustrated in FIG. 20.

FIG. 22 is a sectional view illustrating a state in which the first moving body further moves from the state illustrated in FIG. 21.

FIG. 23 is a sectional view of the electrical circuit breaker device according to a fifth embodiment in an assembled state.

FIG. 24 is a sectional view illustrating a state in which the first moving body moves from the state illustrated in FIG. 23.

FIG. 25 is a sectional view illustrating a state in which the first moving body further moves from the state illustrated in FIG. 24.

FIG. 26 is a sectional view of the electrical circuit breaker device according to a sixth embodiment in an assembled state.

FIG. 27 is a sectional view illustrating a state in which the first moving body moves from the state illustrated in FIG. 26.

FIG. 28 is a sectional view illustrating a state in which the first moving body further moves from the state illustrated in FIG. 27.

FIG. 29 is a perspective view of a state in which a housing is removed to illustrate an internal structure of an electrical circuit breaker device according to a seventh embodiment.

FIG. 30 is a sectional view of the electrical circuit breaker device according to the seventh embodiment in an assembled state.

FIG. 31 is a sectional view illustrating a state in which the first moving body moves from the state illustrated in FIG. 30.

FIG. 32 is a sectional view illustrating a state in which the first moving body further moves from the state illustrated in FIG. 31.

FIG. 33 is an exploded overall perspective view illustrating the electrical circuit breaker device according to an eighth embodiment.

FIG. 34(a) is a sectional view taken along line L-L in FIG. 33, and FIG. 34(b) is a sectional view taken along line M-M in FIG. 33.

FIG. 35 is a sectional view illustrating a state in which the first moving body moves from the state illustrated in FIG. 34.

FIG. 36 is a sectional view illustrating a state in which the first moving body further moves from the state illustrated in FIG. 35.

### REFERENCE SIGNS LIST

301 housing
320 first end portion
330 second end portion
400 to-be-cut portion
420 cutting piece
430 base piece
500 first moving body
600 second moving body
800 fuse functional circuit portion
740 fusion portion
P power source
Q arc-extinguishing material
V electrical circuit breaker device

### DESCRIPTION OF EMBODIMENTS

Hereinafter, each embodiment of the present invention will be described with reference to the drawings. The shape, material, and the like of each member of the electrical circuit breaker device according to the embodiment described below are merely examples, and are not limited thereto.

### First Embodiment

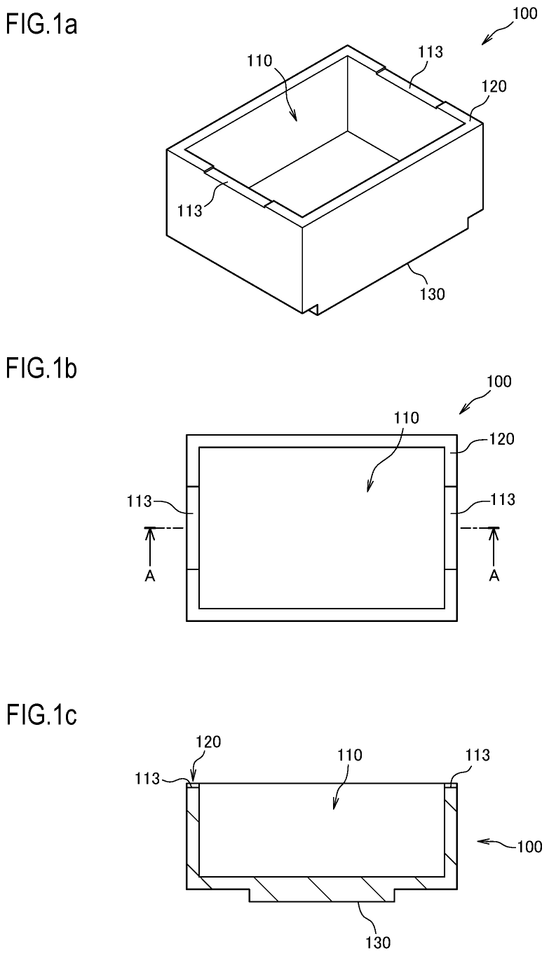

First, FIG. 1 illustrates a lower housing 100 constituting a housing 301 of an electrical circuit breaker device V according to a first embodiment of the present invention. Note that FIG. 1(a) is an overall perspective view of the lower housing 100, FIG. 1(b) is a plan view of the lower housing 100, and FIG. 1(c) is a sectional view of the lower housing 100 taken along line A-A.

As illustrated in FIG. 1, the lower housing 100 is a substantially quadrangular prism body made of an insulator such as a synthetic resin, and has a lower accommodating portion 110 that is hollow inside. The lower accommodating portion 110 is configured to extend from the upper surface 120 toward the lower surface 130 of the lower housing 100, and accommodate a second moving body to be described later. In addition, a part of the upper surface 120 has a placement portion 113 recessed in accordance with the shape of a base piece to place the base piece of a circuit portion to be described later. The placement portion 113 is arranged in a manner of facing both sides of the lower accommodating portion 110, and the placement portion 113 supports the circuit portion, which linearly extends, on both sides.

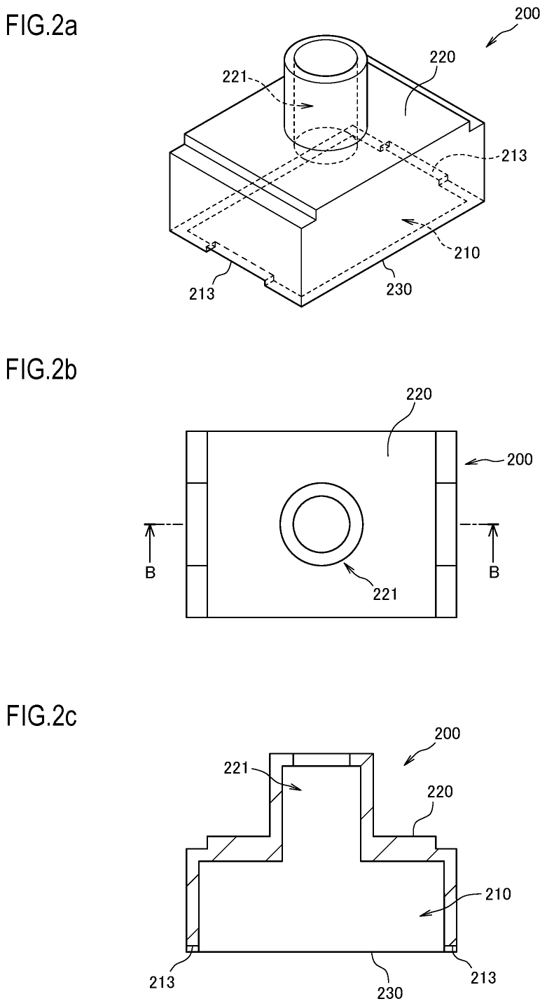

Next, FIG. 2 illustrates an upper housing 200 constituting the housing 301 according to the first embodiment of the present invention. FIG. 2(a) is an overall perspective view of the upper housing 200, FIG. 2 (b) is a plan view of the upper housing 200, and FIG. 2(c) is a sectional view of the upper housing 200 taken along line B-B.

As illustrated in FIG. 2, the upper housing 200 is a substantially quadrangular prism body made of an insulator such as a synthetic resin, and constitutes a housing 301 together with the lower housing 100 illustrated in FIG. 1 and an intermediate housing 300 to be described later. The upper housing 200 has an upper accommodating portion 210 that is hollow inside, and the upper accommodating portion 210 is configured to extend from the lower surface 230 toward the upper surface 220 of the upper housing 200 and accommodate a first moving body to be described later.

Further, a part of the lower surface 230 has an insertion portion 213 recessed in accordance with the shape of the base piece to insert the base piece of the to-be-cut portion to be described later. The insertion portion 213 is arranged in a manner of facing both sides of the upper accommodating portion 210, and is arranged at a position corresponding to a placement portion of the intermediate housing 300 to be described later. Therefore, the insertion portion 213 is fitted from above to the base piece of the to-be-cut portion placed on the placement portion of the intermediate housing 300.

Furthermore, a power source accommodating portion 221 in which the power source P is accommodated is formed on the upper surface 220 side of the upper housing 200. The power source accommodating portion 221 communicates with the upper end side of the upper accommodating portion 210. As described in detail later, power such as air pressure generated from the power source P accommodated in the power source accommodating portion 221 is transmitted to the first moving body in the upper accommodating portion 210 to move the first moving body.

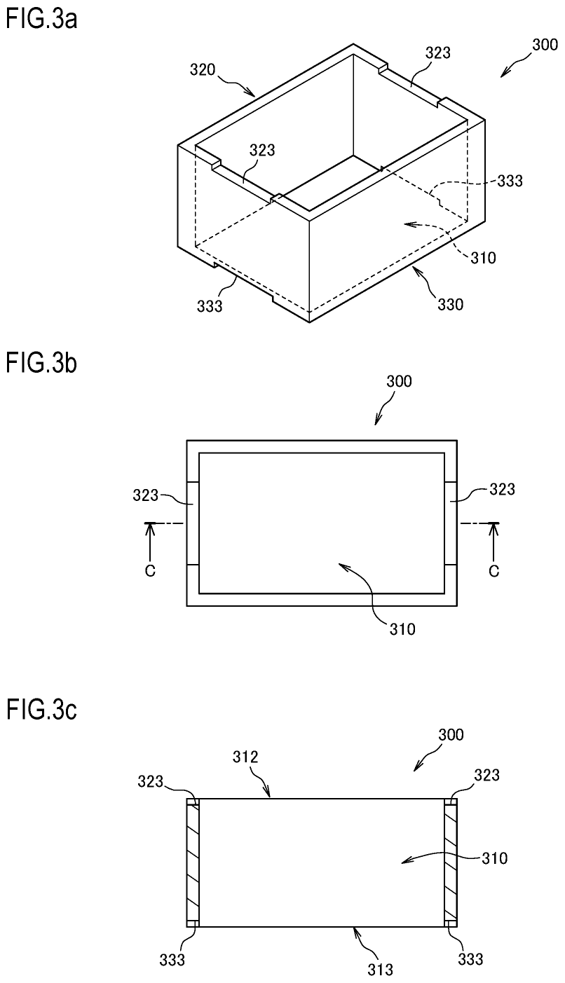

Next, FIG. 3 illustrates an intermediate housing 300 constituting the housing 301 according to the first embodiment of the present invention. FIG. 3(a) is an overall perspective view of the intermediate housing 300, FIG. 3(b) is a plan view of the intermediate housing 300, and FIG. 3(c) is a sectional view of the intermediate housing 300 taken along line C-C.

As illustrated in FIG. 3, the intermediate housing 300 is a substantially quadrangular prism body made of an insulator such as synthetic resin, and constitutes the housing 301 together with the lower housing 100 illustrated in FIG. 1 and the upper housing 200 illustrated in FIG. 2. The intermediate housing 300 includes an intermediate accommodating portion 310 that is hollow inside, and the intermediate accommodating portion 310 is configured to extend from the upper surface 312 toward the lower surface 313 of the intermediate housing 300 and accommodate a second moving body to be described later.

In addition, a part of the upper surface 312 has a placement portion 323 recessed in accordance with the shape of a base piece to place the base piece of the to-be-cut portion to be described later. The placement portion 323 is arranged in a manner of facing both sides of the intermediate accommodating portion 310, and the placement portion 323 supports the to-be-cut portion, which linearly extends, on both sides. In addition, a part of the lower surface 313 has an insertion portion 333 recessed in accordance with the shape of a base piece to insert the base piece of the circuit portion to be described later. The insertion portion 333 is arranged in a manner of facing both sides of the intermediate accommodating portion 310, and is arranged at a position corresponding to the placement portion 113 of the lower housing 100. Therefore, the insertion portion 333 is fitted from above to the base piece of the circuit portion placed on the placement portion 113 of the lower housing 100.

The lower housing 100, the upper housing 200, and the intermediate housing 300 are substantially quadrangular prismatic bodies made of synthetic resin, and are not limited thereto, and may have any shape made of other materials as long as they have high insulation and strength enough to withstand use.

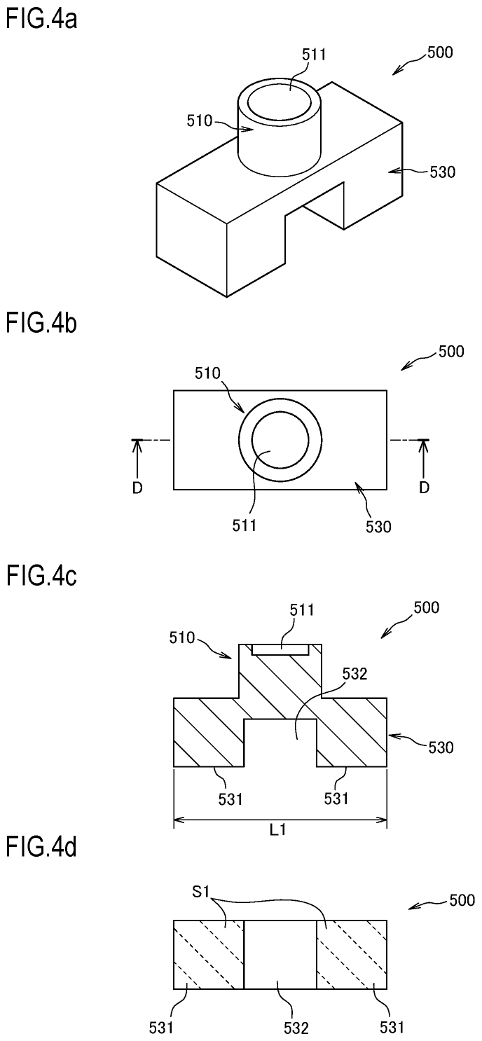

Next, FIG. 4 illustrates a first moving body 500 according to the first embodiment of the present invention. FIG. 4(a) is a perspective view of the first moving body 500, FIG. 4(b) is a plan view of the first moving body 500, FIG. 4(c) is a sectional view of the first moving body 500 taken along line D-D, and FIG. 4(d) is a bottom view of the first moving body 500.

As illustrated in FIG. 4, the first moving body 500 is made of an insulator such as a synthetic resin, and includes an upper end portion 510 of a substantially cylindrical body protruding to the upper end, and a main body portion 530 that is a substantially rectangular parallelepiped. A caved portion 511 is provided at the upper end of the upper end portion 510, and the caved portion 511 is a portion facing the power source P. The main body portion 530 has a shape corresponding to the inner surface shape of the accommodating space 302 of the housing 301, and the main body portion 530 slides on the inner surface of the accommodating space 302, so that the first moving body 500 can smoothly slide while maintaining the posture along the inner side of the accommodating space 302. The lower end side of the main body portion 530 includes a protruding portion 531 protruding downward and a recess portion 532 recessed upward from the protruding portion 531. The protruding portion 531 is arranged on both sides of the recess portion 532, and as will be described later, is a portion that abuts on the cutting piece 420 of the to-be-cut portion 400 and applies a pressing force to cut off the cutting piece 420. Further, as illustrated in FIG. 4(d), the sum of the contact areas of the respective protruding portion 531 and the cutting piece 420 acting at the time of cutting off is S1 (the area S1 is indicated by a chain line in FIG. 4(d)). In addition, the length from the end portion of the one protruding portion 531 to the end portion of the other protruding portion 531 is L1.

Note that the first moving body 500 is made of a synthetic resin, and is not limited thereto, and may have any shape made of another material as long as the first moving body 500 has high insulating properties and has strength enough to withstand use.

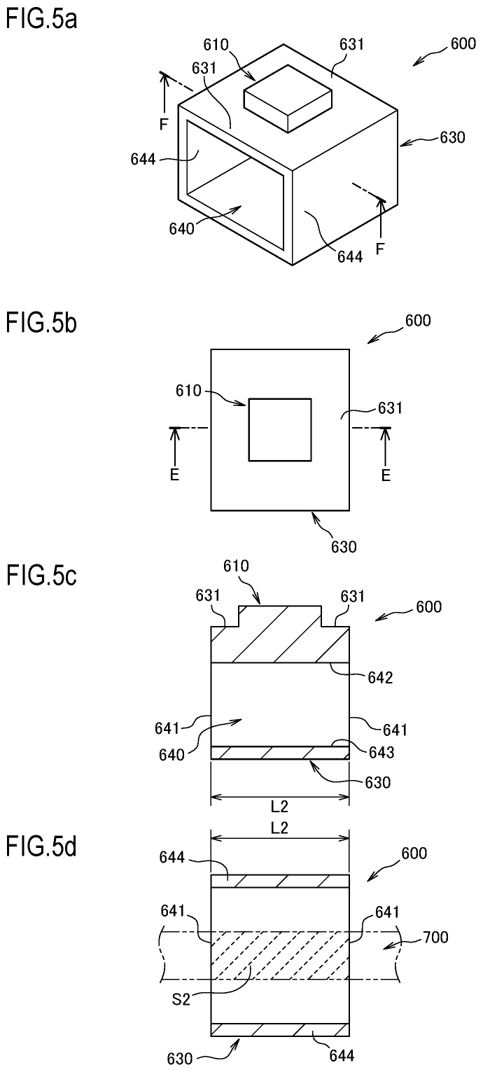

Next, FIG. 5 illustrates a second moving body 600 according to the first embodiment of the present invention. FIG. 5(a) is a perspective view of the second moving body 600, FIG. 5(b) is a plan view of the second moving body 600, FIG. 5(c) is a sectional view of the second moving body 600 taken along line E-E, and FIG. 5(d) is a sectional view of the second moving body 600 taken along line F-F.

As illustrated in FIG. 5, the second moving body 600 is made of an insulator such as a synthetic resin, and includes an upper end portion 610 that is a substantially quadrangular prism protruding to the upper end and a main body portion 630 that is a substantially rectangular parallelepiped. An upper surface of the upper end portion 610 is configured to be a flat surface and can be inserted into the recess portion 532 of the first moving body 500. The main body portion 630 has a shape corresponding to the inner surface shape of the accommodating space 302 of the housing 301, and the main body portion 630 slides on the inner surface of the accommodating space 302, so that the second moving body 600 can smoothly slide while maintaining the posture along the inner side of the accommodating space 302. In addition, the upper end of the main body portion 630 is a flat abutting portion 631, and is configured in such a manner that the protruding portion 531 of the first moving body 500 moved downward can abut the abutting portion 631 after cutting off the cutting piece 420 of the to-be-cut portion 400 as will be described later.

In addition, the inside of the main body portion 630 is hollow, and is an accommodating space 640 into which a part of the circuit portion to be described later can be inserted and in which an arc-extinguishing material can be accommodated. Since both sides of the accommodating space 640 are the opening portions 641, a part of the circuit portion to be described later can be inserted inside the accommodating space 640 through the opening portions 641. In addition, the accommodating space 640 includes an upper wall 642 and a lower wall 643 on the upper and lower sides, and includes side walls 644 on the left and right sides. Therefore, the accommodating space 640 can surround a part of the inserted circuit portion in the circumferential direction. Since the arc-extinguishing material can be accommodated in the accommodating space 640, the periphery of a part of the inserted circuit portion can be filled with the arc-extinguishing material. As will be described later, the second moving body 600 cuts off a part of the circuit portion through the arc-extinguishing material accommodated in the accommodating space 640, and the contact area is S2 where the arc-extinguishing material and the part of the circuit portion are in contact with each other in the accommodating space 640. Note that FIG. 5(d) illustrates a part of the circuit portion 700 inserted through the accommodating space 640 by a virtual line. The length from one opening portion 641 to the other opening portion 641 is L2.

Note that the second moving body 600 is made of a synthetic resin, and is not limited thereto, and may have any shape made of another material as long as the second moving body 600 has high insulating properties and has strength enough to withstand use.

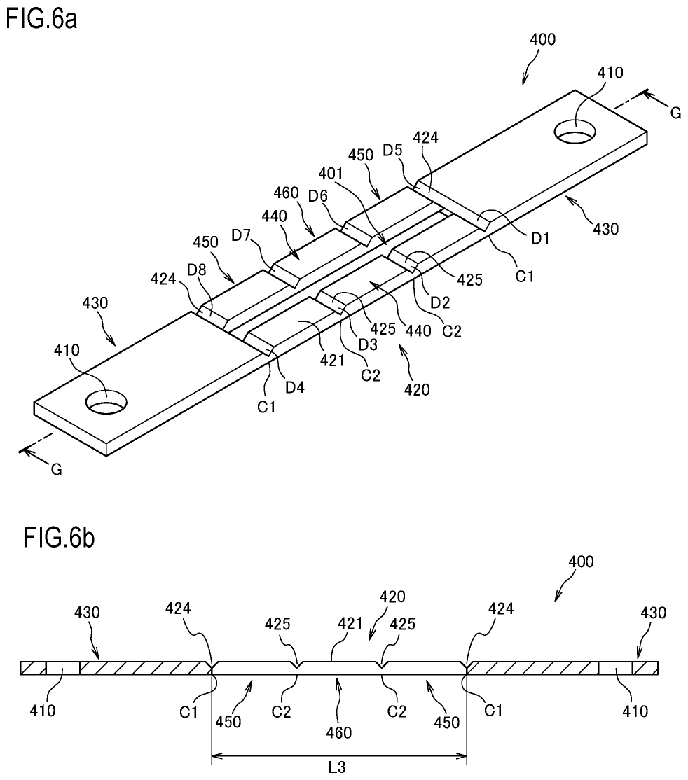

Next, FIG. 6 illustrates a to-be-cut portion 400 constituting a part of the electrical circuit that is broken by the electrical circuit breaker device V according to the first embodiment of the present invention. FIG. 6(a) is a perspective view of the to-be-cut portion 400, and FIG. 6(b) is a sectional view of the to-be-cut portion 400 taken along line G-G.

The to-be-cut portion 400 is entirely made of a metal conductor such as copper in order to be electrically connected to the electrical circuit, and includes base pieces 430 for connecting to the electrical circuit at both ends and a cutting piece 420 positioned between the base pieces 430. A connection hole 410 used for connection with an electrical circuit is formed at an end portion of the base piece 430. Further, since the through hole 401 is provided at the substantially center of the cutting piece 420, the cutting piece 420 is separated by the through hole 401 to form current dividing paths 440 connected in parallel to each other. Furthermore, on a front surface 421 of a boundary portion between the base piece 430 and the cutting piece 420, a cut 424 that is linear is provided in a manner of traversing in the width direction of the to-be-cut portion 400 in order to facilitate cutting off of the cutting piece 420 from the base piece 430. Further, a cut 425 that is linear is provided on the front surface 421 of the cutting piece 420 in a manner of traversing in the width direction of the to-be-cut portion 400 in order to facilitate cutting off of the substantially central side of the cutting piece 420.

Then, as will be described later, when the cutting piece 420 of the to-be-cut portion 400 is cut off by the first moving body 500, the cutting piece 420 is cut off and separated from the base piece 430 at the cutting portion C1 near the cut 424. Further, the substantially center of the cutting piece 420 is also cut off and separated at a cutting portion C2 near the cut 425. Therefore, the cutting piece 420 is cut off and separated into the end portion separation pieces 450 on both sides and the intermediate separation piece 460 therebetween by the cutting portion C1 and the cutting portion C2. The length from the cutting portion C1 between the cutting piece 420 and the one base piece 430 to the cutting portion C1 between the cutting piece 420 and the other base piece 430 is L3.

As described above, since the cutting piece 420 is cut off into a plurality of portions and separated, the voltage applied to the to-be-cut portion 400 can be divided when an abnormal current flows, and an arc to be described later can be more effectively extinguished. Further, since the cutting piece 420 is separated by the through hole 401 and forms the current dividing paths 440 connected in parallel to each other, an abnormal current flowing through the to-be-cut portion 400 can be divided, and an arc to be described later can be more effectively extinguished. As described above, the cutting piece 420 includes a total of eight cutting separation portions (D1 to D8), and a high voltage dividing and current dividing effect can be obtained, and therefore an arc to be described later can be extinguished more effectively and quickly. In particular, in a case where the abnormal current is a relatively high current, it is possible to effectively and quickly extinguish the arc of relatively large energy generated when the cutting piece 420 is cut off.

Note that the to-be-cut portion 400 is not limited to the shape illustrated in FIG. 6, and may have any shape as long as the to-be-cut portion 400 includes the base piece 430 for electrically connecting to the electrical circuit and the cutting piece 420 positioned between the base pieces 430. In addition, although the sectional area of a part of the cutting piece 420 is minimized by the cut to facilitate cutting off, the shape and position of the cut 424 can be appropriately changed to facilitate cutting by the first moving body 500.

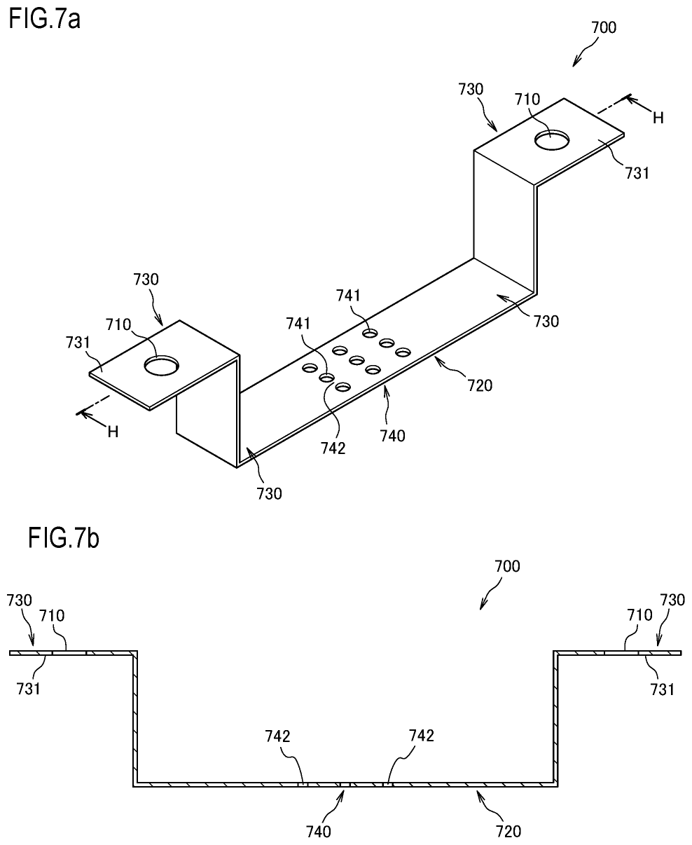

Next, FIG. 7 illustrates a circuit portion 700 constituting a part of the electrical circuit that is broken by the electrical circuit breaker device V according to the first embodiment of the present invention. FIG. 7(a) is a perspective view of the circuit portion 700, and FIG. 7(b) is a sectional view of the circuit portion 700 taken along line H-H.

The circuit portion 700 is entirely made of a metal conductor such as copper in order to be electrically connected to the electrical circuit and the to-be-cut portion 400, and includes the base piece 730 for electrically connecting to the electrical circuit and the to-be-cut portion 400, and the cutting piece 720 positioned between the base pieces 730. The base piece 730 includes a portion adjacent to the cutting piece 720, a portion rising upward from the portion, and an end portion 731 extending laterally from the portion, and a connection hole 710 is formed at a position corresponding to the connection hole 410 of the to-be-cut portion 400 at the end portion 731 of the base piece 730. Further, the cutting piece 720 is configured to be inserted through the accommodating space 640 of the second moving body 600, and as will be described later, the periphery of the cutting piece 720 is surrounded by the arc-extinguishing material accommodated in the accommodating space 640. A fusion portion 740 is provided at the substantially center of the cutting piece 720. The fusion portion 740 includes a narrow portion 742 whose width is locally narrowed by a plurality of through holes 741 provided in the cutting piece 720, and the narrow portion 742 generates heat and fuses to break the current when an abnormal current flows.

Note that the circuit portion 700 is not limited to the shape illustrated in FIG. 7, and may have any shape as long as the circuit portion 700 includes the base piece 730 for electrically connecting to the electrical circuit and the to-be-cut portion 400, and the cutting piece 720, on which the fusion portion 740 is formed, positioned between the base pieces 730. Further, the fusion portion 740 of the cutting piece 720 includes the narrow portion 742, and is not limited thereto, and the fusion portion 740 may have any configuration as long as the fusion portion 740 can generate heat and fuse to broken the current when abnormal current flows.

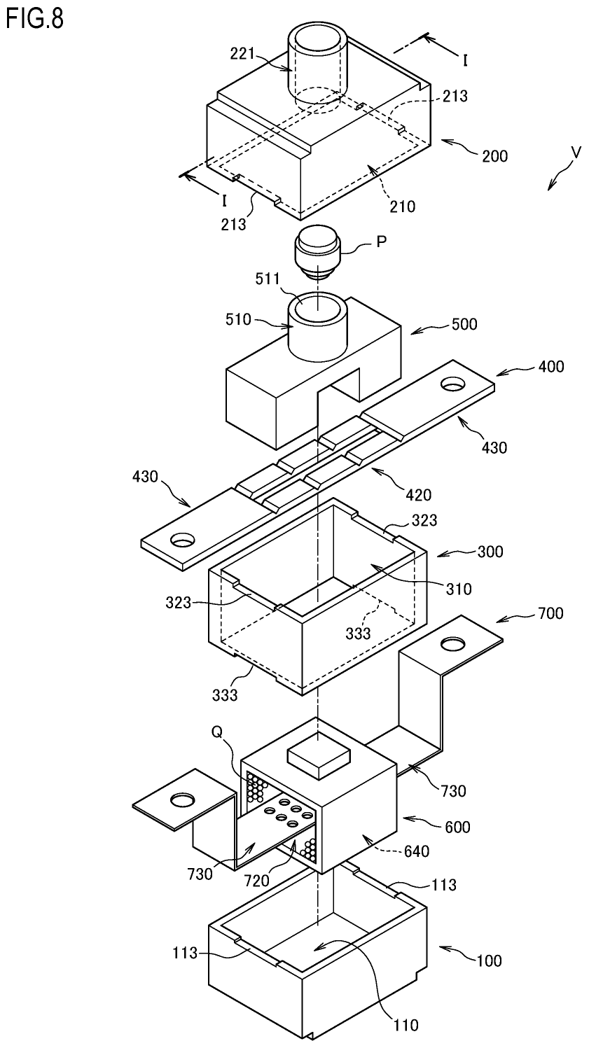

Next, how to assemble the electrical circuit breaker device V of the present invention will be described with reference to FIG. 8. FIG. 8 is an exploded perspective view illustrating the electrical circuit breaker device V.

When the electrical circuit breaker device V is being assembled, first, the cutting piece 720 of the circuit portion 700 is inserted through the accommodating space 640 of the second moving body 600. Then, the substantially lower half of the second moving body 600 is accommodated in the lower accommodating portion 110 of the lower housing 100 in a state in which the cutting piece 720 of the circuit portion 700 is inserted inside. At this time, the base piece 730 of the circuit portion 700 is placed on the placement portion 113 of the lower housing 100, and the circuit portion 700 is arranged in such a manner that the cutting piece 720 traverses the lower accommodating portion 110 of the lower housing 100.

Next, the intermediate housing 300 is fitted from above the lower housing 100 in such a manner that the substantially upper half of the second moving body 600 is inserted into the intermediate accommodating portion 310 of the intermediate housing 300. Then, the insertion portion 333 of the intermediate housing 300 is fitted to the base piece 730 of the circuit portion 700, and the base piece 730 of the circuit portion 700 is sandwiched from above and below by the insertion portion 333 of the intermediate housing 300 and the placement portion 113 of the lower housing 100 to fix the circuit portion 700 not to deviate. In this state, the second moving body 600 is accommodated in the lower accommodating portion 110 of the lower housing 100 and the intermediate accommodating portion 310 of the intermediate housing 300, and the cutting piece 720 of the circuit portion 700 is inserted through the accommodating space 640 of the second moving body 600. By filling the accommodating space 640 of the second moving body 600 with the arc-extinguishing material Q, the cutting piece 720 is surrounded by the arc-extinguishing material Q. The arc-extinguishing material Q (illustrated by an oblique line in FIG. 8) is an arc-extinguishing material, which is granular, made of silica sand or the like, and is configured to extinguish an arc generated between the base pieces 730 after the fusion portion 740 of the cutting piece 720 is fused. Note that, since it is assumed that the fault current belongs to a relatively large current range, in order to effectively and quickly extinguish the arc, the arc-extinguishing material Q is compressed so that the bulk density of the arc-extinguishing material Q filled around the accommodating space 640 of the second moving body 600 becomes extremely high. Therefore, the arc-extinguishing material Q does not collapse and flow out of the accommodating space 640 of the second moving body 600.

Next, the to-be-cut portion 400 is arranged in such a manner that the base piece 430 of the to-be-cut portion 400 is placed on the placement portion 323 of the intermediate housing 300, and the cutting piece 420 traverses above the intermediate accommodating portion 310 of the intermediate housing 300. Further, the upper housing 200 is fitted from above the intermediate housing 300 in such a manner that the first moving body 500 is inserted into the upper accommodating portion 210 of the upper housing 200. Then, the insertion portion 213 of the upper housing 200 is fitted to the base piece 430 of the to-be-cut portion 400. Then, by coupling and fixing the upper housing 200, the intermediate housing 300, and the lower housing 100 aligned vertically to each other with a coupling tool such as a screw, the housing 301 including the upper housing 200, the intermediate housing 300, and the lower housing 100 is assembled in a state in which the first moving body 500, the to-be-cut portion 400, the second moving body 600, and the circuit portion 700 are accommodated inside.

Further, the power source P is attached to the power source accommodating portion 221 of the upper housing 200, and a part of the power source P is accommodated in the caved portion 511 of the first moving body 500. In addition, when it is detected that an abnormal current flows through the electrical circuit, an abnormal signal is input from an external device to the power source P. Then, for example, the gunpowder inside the power source P is exploded, and the first moving body 500 is instantaneously pushed out and moved in the accommodating space 302 of the housing 301 by the air pressure due to the explosion. The power source P is not limited to a power source using gunpowder as long as the power source P generates power for moving the first moving body 500, and other known power sources may be used.

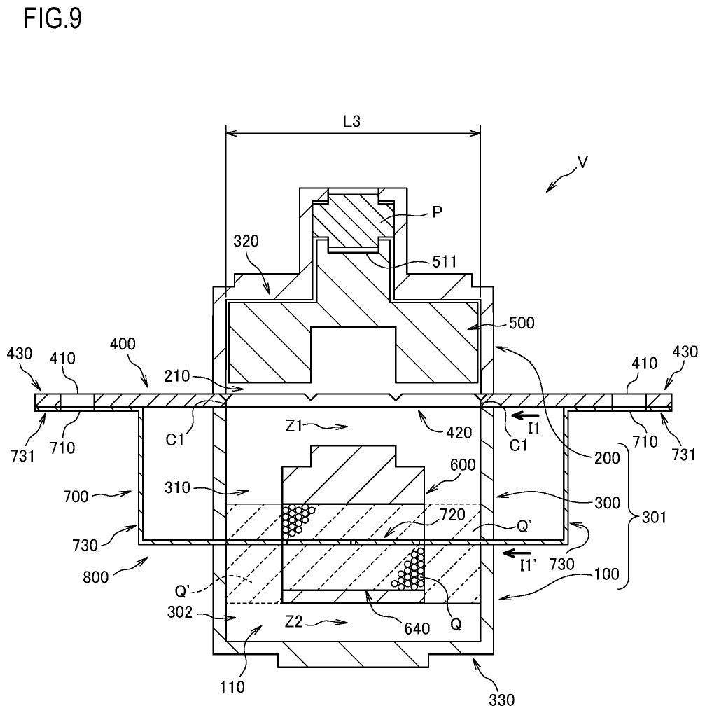

Next, an internal structure of the electrical circuit breaker device V according to the first embodiment of the present invention will be described with reference to FIG. 9. FIG. 9 is a sectional view, taken along line I-I, of the electrical circuit breaker device V illustrated in FIG. 8 in an assembled state.

As illustrated in FIG. 9, the first moving body 500 is accommodated in an accommodating space 302 including a lower accommodating portion 110, an intermediate accommodating portion 310, and an upper accommodating portion 210 aligned linearly. The accommodating space 302 extends from the first end portion 320 of the housing 301 to the second end portion 330 on the opposite side of the first end portion 320. The first moving body 500 is arranged on the first end portion 320 side where the power source P is arranged, and the second moving body 600 is arranged in a manner of being vertically aligned on the lower side (the second end portion 330 side) of the first moving body 500. Furthermore, a space Z1 exists between the first moving body 500 and the second moving body 600 in the traveling direction (that is, the direction from the first end portion 320 to the second end portion 330) of the first moving body 500. In addition, a space Z2 exists between the second moving body 600 and the second end portion 330 in the traveling direction of the first moving body 500. Therefore, as will be described later, the first moving body 500 moves from the first end portion 320 toward the second end portion 330 and abuts on the second moving body 600, and the second moving body 600 is pushed by the first moving body 500 and can move from the first end portion 320 toward the second end portion 330.

In addition, since the caved portion 511 on the upper end side of the first moving body 500 is adjacent to the power source P, the air pressure due to the explosion of the gunpowder in the power source P is transmitted to the upper end side of the first moving body 500 as will be described later. In addition, the base piece 430 of the to-be-cut portion 400 and the end portion 731 of the base piece 730 of the circuit portion 700 are vertically overlapped and electrically connected to each other. Therefore, the to-be-cut portion 400 and the circuit portion 700 are connected in parallel. Further, when a coupling member such as a bolt is inserted through and fastened to the connection hole 410 of the to-be-cut portion 400 and the connection hole 710 of the circuit portion 700, the base piece 430 of the to-be-cut portion 400 and the base piece 730 of the circuit portion 700 are firmly fixed. As illustrated in FIGS. 8 and 9, in the electrical circuit breaker device V, the circuit portion 700, including the fusion portion 740, and the arc-extinguishing material Q constitute a fuse functional circuit portion 800. As will be described later, when the second moving body 600 moves, the cutting piece 720 of the circuit portion 700 which is a part of the fuse functional circuit portion 800 is cut off.

As illustrated in FIG. 9, the assembled and completed electrical circuit breaker device V is used by being attached in an electrical circuit to be protected. Specifically, the base piece 430 of the to-be-cut portion 400 and the base piece 730 of the circuit portion 700 are connected to a part of the electrical circuit, and the to-be-cut portion 400 and the fuse functional circuit portion 800 constitute a part of the electrical circuit. The first moving body 500 is arranged away from the cutting piece 420 of the to-be-cut portion 400. In the normal state (that is, when no abnormal current flows), since the base piece 430 and the cutting piece 420 of the to-be-cut portion 400 are not cut off and are physically and electrically connected, a current I1 flows through the electrical circuit via the base piece 430 and the cutting piece 420 of the to-be-cut portion 400. Note that the cutting piece 720 of the circuit portion 700 of the fuse functional circuit portion 800 is not cut off, and is inserted through the accommodating space 640 of the second moving body 600 to be physically and electrically connected to the base pieces 730 on both sides. The to-be-cut portion 400 and the circuit portion 700 are connected in parallel, and the resistance value of the circuit portion 700 is larger than the resistance value of the to-be-cut portion 400. Since the magnitude of the current I1 flowing through the to-be-cut portion 400 and the magnitude of a current I1′ flowing through the circuit portion 700 are proportional to the reciprocal of each resistance value, the magnitude of the current I1′ at the normal time is as small as about ten percent of the total current (current I1+current I1′).

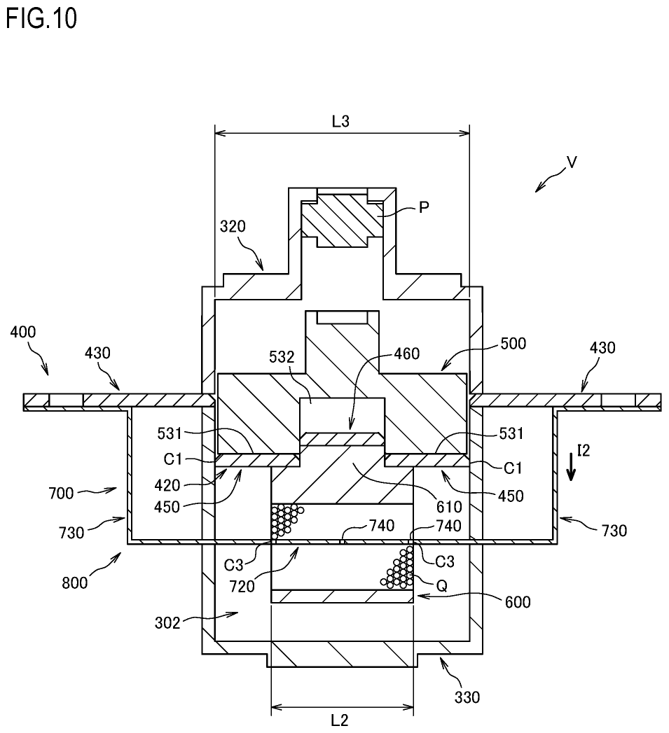

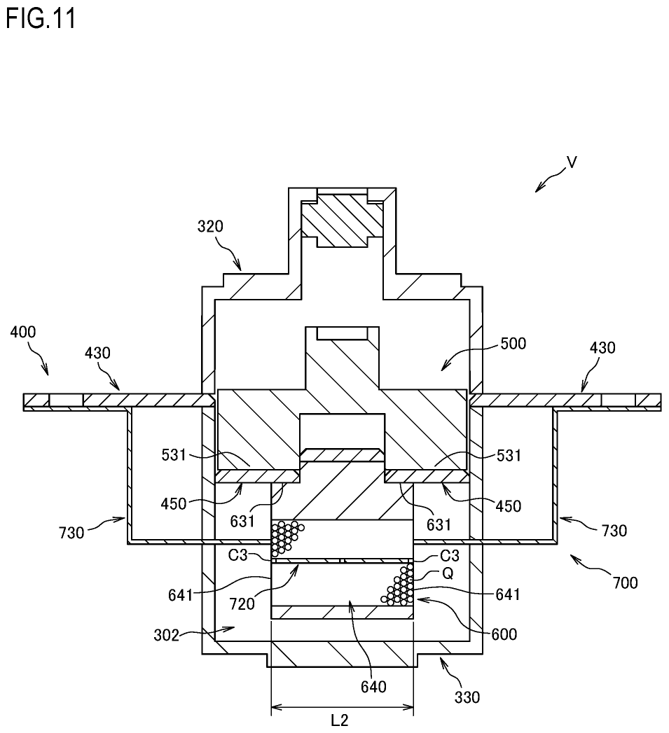

Next, a state in which the electrical circuit breaker device V breaks the electrical circuit in a case where an abnormality such as overcurrent flowing through the electrical circuit is detected will be described with reference to FIGS. 10 and 11. FIG. 10 is a sectional view illustrating a state in which the first moving body 500 moves from the state illustrated in FIG. 9, and FIG. 11 is a sectional view illustrating a state in which the first moving body 500 further moves from the state illustrated in FIG. 10.

First, as illustrated in FIG. 10, in a case where an abnormality such as overcurrent flowing through the electrical circuit is detected, an abnormal signal is input to the power source P, and the gunpowder in the power source P explodes. Then, the air pressure due to the explosion is transmitted to the caved portion 511 on the upper end side of the first moving body 500. Then, the first moving body 500 is vigorously blown away from the first end portion 320 toward the second end portion 330 by the air pressure, and instantaneously moves in the accommodating space 302 toward the second end portion 330.

When the first moving body 500 further moves toward the second end portion 330, the cutting piece 420 of the to-be-cut portion 400 is strongly pushed downward by the protruding portion 531 of the first moving body 500. Then, the cutting piece 420 is divided, and the base pieces 430 on both sides are physically cut off. That is, the state is broken in which the base pieces 430 on both sides of the to-be-cut portion 400 are energized via the cutting piece 420, and an overcurrent can be prevented from flowing through the electrical circuit.

When the cutting piece 420 of the to-be-cut portion 400 is cut off by the first moving body 500, the cutting piece 420 is separated into the intermediate separation piece 460 and the end portion separation pieces 450 on both sides. Then, the end portion separation pieces 450 on both sides are pushed downward by the protruding portion 531 of the first moving body 500, and the intermediate separation piece 460 abuts on the upper end portion 610 of the second moving body 600 and remains in the recess portion 532 of the first moving body 500. Therefore, the separated intermediate separation piece 460 and the end portion separation pieces 450 are vertically separated in the traveling direction of the first moving body 500. Accordingly, in a case where an arc is slightly generated between the intermediate separation piece 460 and the end portion separation piece 450 when the cutting piece 420 is cut off, the arc can still be effectively and quickly extinguished. In particular, since the cutting piece 420 is cut off into a plurality of portions and separated, a high voltage dividing and current dividing effect can be obtained, the arc that can be generated when the cutting piece 420 is cut off can be extinguished more effectively and quickly.

Here, in a case where the abnormal current is a relatively large current, a large voltage is applied to the base pieces 430 on both sides connected to the electrical circuit. Therefore, after the cutting piece 420 is cut off, there is still a possibility that an arc continues to generate between the base pieces 430 and the cutting piece 420 which has been cut off. However, as illustrated in FIG. 10, since the base piece 430 of the to-be-cut portion 400 and the base piece 730 of the circuit portion 700 are electrically connected before the cutting piece 420 of the to-be-cut portion 400 is cut off, when the cutting piece 420 is cut off, the fault current I2 flowing through the electrical circuit is induced to the fusion portion 740 of the cutting piece 720 via the base piece 730. Therefore, it is possible to prevent the arc from being continuously generated between the divided cutting piece 420 and the base piece 430.

Then, as illustrated in FIG. 10, the fusion portion 740 of the circuit portion 700 generates heat and fuses due to the fault current I2 induced to the circuit portion 700. When the cutting piece 420 is cut off by the first moving body 500 to break the electrical circuit, the fault current I2 is induced to the circuit portion 700, and the current flows through the electrical circuit. Therefore, strictly speaking, the electrical circuit is not completely broken. However, since the rating of the fusion portion 740 of the circuit portion 700 is reduced, the fusion portion 740 is immediately fused by the fault current I2, and the electrical circuit is immediately completely broken.

Further, at the time of fusing the fusion portion 740, an arc is generated around the fusion portion 740 by the voltage applied to the base pieces 730 on both sides connected to the electrical circuit, but the arc is quickly and effectively extinguished by the arc-extinguishing material Q filled around the fusion portion 740.

As described above, according to the electrical circuit breaker device V of the present invention, the current (fault current) flowing through the electrical circuit when the electrical circuit is broken is induced to the circuit portion 700 of the fuse functional circuit portion 800, and the arc generated by the induced current is effectively and quickly extinguished in the fusion portion 740 of the circuit portion 700. In particular, a voltage applied to an electrical circuit tends to increase due to recent improvement in performance of automobiles and the like (for example, the voltage reaches 500 V to 1000 V), and an arc generated from a current (fault current) flowing through the electrical circuit when the electrical circuit is broken also increases. Therefore, according to the electrical circuit breaker device V of the present invention, since the state is broken in which the to-be-cut portion 400 is energized and the state is secured in which the to-be-cut portion 400 and the fuse functional circuit portion 800 are connected before the arc due to the fault current generates between the base pieces 430 on both sides, the arc due to the fault current can be reliably induced to the fuse functional circuit portion 800, and the arc can be extinguished by the fusion portion 740 and the arc-extinguishing material Q of the fuse functional circuit portion 800. As a result, it is possible to prevent, in the housing 301, the electrical circuit breaker device V from being damaged by generation of an arc due to a fault current between the base pieces 430, and to safely break the electrical circuit.

Next, as illustrated in FIG. 11, after the cutting piece 420 is cut off, the first moving body 500 continuously moves in the accommodating space 302 from the first end portion 320 to the second end portion 330. Then, the first moving body 500 abuts on the upper end side (the first end portion 320 side) of the second moving body 600, and the first moving body 500 pushes out the second moving body 600 strongly toward the second end portion 330 side. Specifically, the protruding portion 531 of the first moving body 500 abuts on the abutting portion 631 of the second moving body 600 in a state of sandwiching the end portion separation piece 450, the power of the first moving body 500 is transmitted to the second moving body 600, and the second moving body 600 moves toward the second end portion 330 side by the first moving body 500.

Then, the cutting piece 720 inserted through the accommodating space 640 of the second moving body 600 is strongly pushed downward by the second moving body 600 moving toward the second end portion 330. Then, the cutting piece 720 is divided, and the base pieces 730 on both sides are physically cut off. Since the accommodating space 640 is filled with the arc-extinguishing material Q, the pressing force by which the second moving body 600 is pushed out toward the second end portion 330 is effectively transmitted to the cutting piece 720 by the arc-extinguishing material Q surrounding the periphery of the cutting piece 720. Therefore, the cutting piece 720 is reliably cut off and separated from the base pieces 730 on both sides.

Note that in a case where the abnormal current is a relatively large current, as illustrated in FIG. 10, the fusion portion 740 is fused to break the electrical circuit. Here, as illustrated in FIG. 11, after the fusion portion 740 is fused and the electrical circuit is cut off, the electrical circuit is still physically and more reliably broken by cutting the cutting piece 720 of the circuit portion 700 and separating the cutting piece 720 from the base piece 730. Note that in the vicinity of the opening portion 641 of the second moving body 600, the cutting piece 720 is cut off from one base piece 730 at the cutting portion C3 and cut off from the other base piece 730 at the cutting portion C3. The length between the cutting portions C3 on both sides is a length L2. The length L2 is equal to the length between the opening portions 641 on both sides of the second moving body 600.

On the other hand, in a case where the abnormal current is a relatively low current, as illustrated in FIG. 10, when the cutting piece 420 of the to-be-cut portion 400 is cut off, the fault current I2 flowing through the electrical circuit is induced to the fusion portion 740 of the cutting piece 720 via the base pieces 730. Therefore, it is possible to prevent generation of an arc between the divided cutting piece 420 and the base piece 430.

However, in a case where the fault current I2 induced to the fuse functional circuit portion 800 belongs to a relatively low current range, there may be a case where the fusion portion 740 of the fuse functional circuit portion 800 is not fused and the current cannot be broken, or a case where it takes a relatively long time to break the current and the overcurrent flowing through the electrical circuit cannot be broken immediately.

However, as illustrated in FIG. 11, the second moving body 600 pushed out by the first moving body 500 cuts off the cutting piece 720 of the circuit portion 700 and separates the cutting piece 720 from the base piece 730. Therefore, in a case where the fusion portion 740 is not fused or it takes a relatively long time to break the current, it is still possible to immediately break the state in which the base pieces 730 on both sides of the fuse functional circuit portion 800 are energized via the cutting piece 720, so as to prevent an overcurrent from flowing through the electrical circuit. In addition, in a case where an arc is generated between the cutting piece 720 and the base piece 730 when the cutting piece 720 is cut off, the arc is still effectively extinguished by the arc-extinguishing material Q in the accommodating space 640 through which the cutting piece 720 is inserted.

As described above, according to the electrical circuit breaker device V of the present invention, in a case where an overcurrent belonging to a relatively low current range flows through the electrical circuit, as illustrated in FIG. 10, the first moving body 500 cuts off the cutting piece 420 of the to-be-cut portion 400, and then, as illustrated in FIG. 11, the second moving body 600 cuts off the cutting piece 720 which is a part of the fuse functional circuit portion 800 including the fusion portion 740, thereby preventing the overcurrent from flowing through the electrical circuit. On the other hand, in a case where an overcurrent belonging to a relatively large current range flows through the electrical circuit, as illustrated in FIG. 10, when the first moving body 500 cuts off the cutting piece 420 of the to-be-cut portion 400, a fault current is induced to the fusion portion 740 of the fuse functional circuit portion 800 to be safely broken, thereby preventing the overcurrent from flowing through the electrical circuit. Thus, according to the electrical circuit breaker device V of the present invention, a quick breaking capability is provided for a wide current range, including not only relatively high currents, but also relatively low currents.

In addition, in the electrical circuit breaker device V of the present invention, in a case where the fault current belongs to a relatively large current range, the arc can still be effectively and quickly extinguished by the arc-extinguishing material Q around the fusion portion 740 of the fuse functional circuit portion 800. Since the cutting piece 720 of the circuit portion 700 is cut off through the arc-extinguishing material Q, it is important to efficiently transmit the power of the power source P to the cutting piece 720 through the second moving body 600 and the arc-extinguishing material Q to quickly and reliably cut off the cutting piece 720. In particular, since it is assumed that the fault current belongs to a relatively large current range, in order to effectively and quickly extinguish the arc, the arc-extinguishing material Q is compressed so that the bulk density of the arc-extinguishing material Q filled around the accommodating space 640 of the second moving body 600 becomes extremely high. Furthermore, as illustrated in FIG. 9, when the arc-extinguishing material Q′ extends to the outside of the accommodating space 640, the arc-extinguishing material Q′ having high shear strength also needs to be cut off at the same time, and thus the power of the power source P needs to be transmitted more efficiently. As illustrated in FIG. 9, in a case where the compressed plate-shaped arc-extinguishing material Q′ extends along the cutting piece 720 and the arc-extinguishing material Q′ extends to the outside of the accommodating space 640, the position and posture of the arc-extinguishing material Q′ in the accommodating space 302 of the housing 301 are less likely to deviate.

In the electrical circuit breaker device V according to the present invention, as illustrated in FIGS. 9 and 10, the length L2 between the cutting portions C3 of the cutting piece 720 and each of base pieces 730 of the fuse functional circuit portion 800 is shorter than the length L3 between the cutting portions C1 of the cutting piece 420 and each of the base pieces 430 of the to-be-cut portion 400. That is, the cutting length L2 when the cutting piece 720 is cut off by the second moving body 600 is shorter than the cutting length L3 when the cutting piece 420 is cut off by the first moving body 500. Therefore, the power of the first moving body 500 when the cutting piece 420 is cut off by the first moving body 500 is concentrated and effectively transmitted to the second moving body 600 having a shorter cutting length. Thus, the power of the power source P is efficiently transmitted to the cutting piece 720 of the fuse functional circuit portion 800 through the second moving body 600 and the arc-extinguishing material Q, and the cutting piece 720 can be quickly and reliably cut off. In addition, since the power of the power source P can be efficiently transmitted, the power source P can be reduced by decreasing the amount of gunpowder or the like, which contributes to the downsizing and lightweighting of the housing 301. Furthermore, since the length L2 of the portion where the cutting piece 720 is cut off is shorter than the length L3 of the portion where the cutting piece 420 is cut off, it is possible to further downsize and lightweight the lower housing 100 side accommodating the cutting piece 720.

In the electrical circuit breaker device V of the present invention, as illustrated in FIGS. 9 and 10, the length L2 between the cutting portions C3 of the cutting piece 720 and each of the base pieces 730 of the fuse functional circuit portion 800 is shorter than the length L3 between the cutting portions C1 of the cutting piece 420 and each of the base pieces 430 of the to-be-cut portion 400. However, the length L2 between the cutting portions C3 of the cutting piece 720 and each of the base pieces 730 of the fuse functional circuit portion 800 may be equal to the length L3 between the cutting portions C1 of the cutting piece 420 and each of the base pieces 430 of the to-be-cut portion 400. That is, the cutting length L2 when the cutting piece 720 is cut off by the second moving body 600 is equal to the cutting length L3 when the cutting piece 420 is cut off by the first moving body 500. Then, the power of the first moving body 500 when the cutting piece 420 is cut off by the first moving body 500 is effectively transmitted to the second moving body 600 having the same cutting length without being attenuated as much as possible. Therefore, when the cutting length L2 when the cutting piece 720 is cut off by the second moving body 600 is equal to or less than the cutting length L3 when the cutting piece 420 is cut off by the first moving body 500, that is, the relationship of length L2≤length L3 is satisfied, the power of the power source P is efficiently transmitted to the cutting piece 720 through the second moving body 600 and the arc-extinguishing material Q, and the cutting piece 720 can be quickly and reliably cut off.

In addition, in the electrical circuit breaker device V of the present invention, as illustrated in FIG. 4, when the first moving body 500 cuts off the cutting piece 420, the area of a portion is S1 where the first moving body 500 comes into contact with the cutting piece 420 and applies a pressing force. As illustrated in FIG. 5, when the second moving body 600 cuts off the cutting piece 720, the area of a portion is S2 where the arc-extinguishing material accommodated in the accommodating space 640 comes into contact with the cutting piece 720 and applies a pressing force. The area S2 when the cutting piece 720 is cut off by the second moving body 600 is smaller than the area S1 when the cutting piece 420 is cut off by the first moving body 500. Therefore, the power of the first moving body 500 when the cutting piece 420 is cut off by the first moving body 500 is concentrated and effectively transmitted to the second moving body 600 having a smaller cutting area. Thus, the power of the power source P is efficiently transmitted to the cutting piece 720 through the second moving body 600 and the arc-extinguishing material Q, and the cutting piece 720 can be quickly and reliably cut off. In addition, since the power of the power source P can be efficiently transmitted, the power source P can be reduced by decreasing the amount of gunpowder or the like, which contributes to the downsizing and lightweighting of the housing 301.

In the electrical circuit breaker device V of the present invention, the area S2 when the cutting piece 720 is cut off by the second moving body 600 is smaller than the area S1 when the cutting piece 420 is cut off by the first moving body 500, and the present invention is not limited thereto, and the area S2 when the cutting piece 720 is cut off by the second moving body 600 may be equal to the area S1 when the cutting piece 420 is cut off by the first moving body 500. Then, the power of the first moving body 500 when the cutting piece 420 is cut off by the first moving body 500 is effectively transmitted to the second moving body 600 having the same cutting area without being attenuated as much as possible. Therefore, when the area S2 when the cutting piece 720 is cut off by the second moving body 600 is equal to or less than the area S1 when the cutting piece 420 is cut off by the first moving body 500, that is, the relationship of area S2≤area S1 is satisfied, the power of the power source P is efficiently transmitted to the cutting piece 720 through the second moving body 600 and the arc-extinguishing material Q, and the cutting piece 720 can be quickly and reliably cut off.

Note that the electrical circuit breaker device V of the present invention is configured in such a manner that the relationship of length L2≤length L3 and the relationship of area S2≤area S1 are simultaneously established, and the present invention is not limited thereto, and only one of the relationship of length L2≤length L3 and the relationship of area S2≤area S1 may be established.

In addition, in the electrical circuit breaker device V of the present invention, since it is assumed that an abnormal current belonging to a relatively high current is broken, the periphery of the cutting piece 720 including the fusion portion 740 is surrounded by the arc-extinguishing material Q so that an arc generated between the base pieces 730 can be extinguished after the fusion portion 740 of the fuse functional circuit portion 800 is fused. Since the arc-extinguishing material Q is accommodated in the accommodating space 640 of the second moving body 600 together with the cutting piece 720, the power of the power source P transmitted from the first moving body 500 is efficiently transmitted to the cutting piece 720 via the second moving body 600, and the cutting piece 720 can be quickly and reliably cut off. In a case where the arc-extinguishing material Q is directly filled between the cutting piece 420 of the to-be-cut portion 400 and the cutting piece 720 of the fuse functional circuit portion 800 without using the second moving body 600, the first moving body 500 pushed out downward directly cuts the cutting piece 720 with the cutting piece 420, which has been cut off, interposed therebetween. However, how the force is transmitted to the cutting piece 720 changes depending on the position, posture, shape, and the like of the cutting piece 420, which has been cut off, and the state of the arc-extinguishing material Q, and therefore it becomes difficult to quickly and reliably cut off the cutting piece 720.

In the electrical circuit breaker device V of the present invention, the first moving body 500 and the second moving body 600 are configured separately and independently, and are configured to be individually movable. Here, the present invention is not limited thereto, and the first moving body 500 and the second moving body 600 may be configured to be integrated and simultaneously move. In a case where the first moving body 500 and the second moving body 600 are integrated, it is necessary to provide a gap between the arc-extinguishing material Q and the cutting piece 720 so that the pressing force is not immediately transmitted to the cutting piece 720, for example, so that the order (timing) is that the first moving body 500 cuts off the cutting piece 420 and then the second moving body 600 cuts off the cutting piece 720. Here, in the electrical circuit breaker device V of the present invention, since it is assumed that an abnormal current belonging to a relatively high current is broken, it is desirable that the cutting piece 720 is always surrounded by the arc-extinguishing material Q, and it is desirable that the arc-extinguishing material Q and the second moving body 600 move integrally to quickly and reliably cut off the cutting piece 720.

Therefore, in the electrical circuit breaker device V of the present invention, the first moving body 500 and the second moving body 600 are configured separately and independently, and are configured to be individually movable, so that the cutting piece 720 is always surrounded by the arc-extinguishing material Q in the accommodating space 640 of the second moving body 600, the arc-extinguishing material Q and the second moving body 600 move integrally, and the cutting piece 720 can be quickly and reliably cut off. In addition, since the first moving body 500 and the second moving body 600 are configured to be individually movable, the timing of movement of the first moving body 500 and the second moving body 600 can be easily adjusted, and the configurations of the first moving body 500 and the second moving body 600 can be simplified. For example, when the distance between the first moving body 500 and the second moving body 600 is appropriately changed, it is easy to adjust the cutting off timing of the cutting piece 420 and the cutting piece 720 in accordance with the magnitude of the abnormal current to be broken.

### Second Embodiment

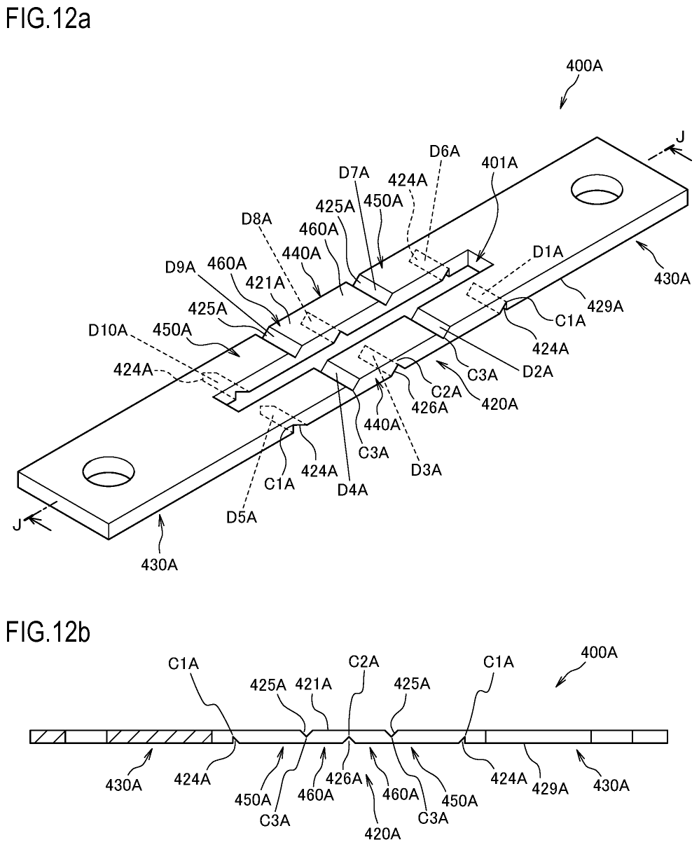

Next, an electrical circuit breaker device VA of the present invention according to the second embodiment will be described with reference to FIGS. 12 to 15. Since the configuration of the electrical circuit breaker device VA according to the second embodiment is basically the same as the configuration of the electrical circuit breaker device V according to the first embodiment, the description of the same configuration is omitted. FIG. 12(a) is a perspective view of a to-be-cut portion 400A constituting a part of an electrical circuit broken by the electrical circuit breaker device VA according to the second embodiment of the present invention, and FIG. 12(b) is a sectional view the to-be-cut portion 400A taken along line J-J.

In the to-be-cut portion 400A, on a back surface 429A of the boundary portion between the base piece 430A and the cutting piece 420A, a cut 424A that is linear is provided in a manner of traversing in the width direction of the to-be-cut portion 400A in order to facilitate cutting off of the cutting piece 420A from the base piece 430A. In addition, in order to further finely divide the cutting piece 420A, two cuts 425A that are linear are provided on the front surface 421A of the cutting piece 420A in a manner of traversing in the width direction of the to-be-cut portion 400. Further, on the back surface 429A of the cutting piece 420A, in order to easily cut off the substantially central side of the cutting piece 420A, a cut 426A that is linear is further provided between the cuts 425A on both sides in a manner of traversing in the width direction of the to-be-cut portion 400A.

Then, as will be described later, when the cutting piece 420A of the to-be-cut portion 400A is cut off by the first moving body 500A, the cutting piece 420A is cut off and separated from the base piece 430A at a cutting portion C1A near the cut 424A. Further, the cutting piece 420A is cut off and separated at a cutting portion C2A near the cut 426A that is in the substantial center and a cutting portion C3A near the cuts 425A on both sides thereof. Therefore, the cutting piece 420A is cut off and separated into the end portion separation pieces 450A on both sides and two intermediate separation pieces 460A therebetween by the cutting portion CIA, the cutting portion C2A, and the cutting portion C3A.

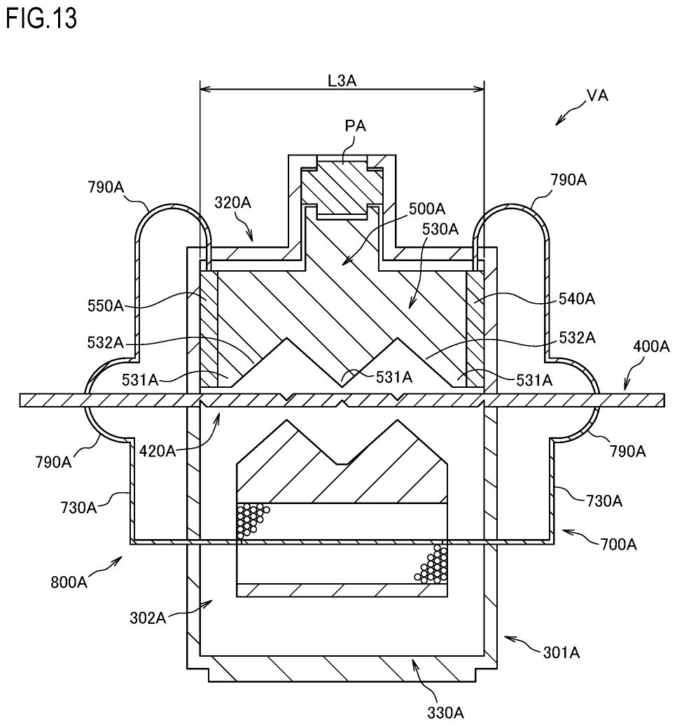

As described above, since the cutting piece 420A is cut off into a plurality of portions and separated, the voltage applied to the to-be-cut portion 400A can be divided when an abnormal current flows, and an arc to be described later can be more effectively extinguished. In particular, since the cutting piece 420A is separated by the through hole 401A and forms current dividing paths 440A connected in parallel to each other, an abnormal current flowing through the to-be-cut portion 400A can be divided, and an arc to be described later can be more effectively extinguished. Since the cutting piece 420A includes a total of ten cutting separation portions (D1A to D10A), a high voltage dividing and current dividing effect can be obtained, and an arc to be described later can be extinguished more effectively and quickly. Further, as will be described later, since the cutting piece 420A is divided at a plurality of places and bent in a substantially M shape, it is possible to prevent the entire length of the cutting piece 420A from becoming long while maintaining a state in which the divided places are separated from each other. As a result, the cutting length (see the length L3A in FIG. 13) when the cutting piece 420A is cut off by the first moving body 500A is prevented from becoming long, which contributes to the downsizing of the electrical circuit breaker device VA.

Next, an internal structure of the electrical circuit breaker device VA according to the second embodiment of the present invention will be described with reference to FIG. 13. Similarly to FIG. 9, FIG. 13 is a sectional view of the electrical circuit breaker device VA according to the second embodiment in an assembled state.

As illustrated in FIG. 13, the first moving body 500A is accommodated in the accommodating space 302A, and is configured to be movable from the first end portion 320A toward the second end portion 330A of the housing 301A. The lower end side of the main body portion 530A of the first moving body 500A includes a protruding portion 531A protruding downward and a recess portion 532A recessed upward from the protruding portion 531A. The three protruding portions 531A are provided on the lower end side of the main body portion 530A, and the recess portion 532A is provided respectively between the protruding portions 531A. Therefore, the lower end side of the main body portion 530A has a substantially M-shaped concavo-convex shape by the protruding portions 531A and the recess portions 532A. Then, as will be described later, the portion having the substantially M-shaped concavo-convex shape becomes a portion that abuts on the cutting piece 420A of the to-be-cut portion 400A and applies a pressing force to cut off the cutting piece 420A.

As illustrated in FIG. 13, before the electrical circuit breaker device VA operates, that is, before the first moving body 500 moves and the cutting piece 420A of the to-be-cut portion 400A starts to be cut off, the to-be-cut portion 400A and the fuse functional circuit portion 800A are not electrically or physically connected to each other. Specifically, a connection member 790A made of a conductor such as an electric wire is coupled to each base piece 730A of the fuse functional circuit portion 800A, and each connection member 790A is not connected to the to-be-cut portion 400A but is electrically connected to a pair of electrode portion 540A and electrode portion 550A provided in the main body portion 530A of the first moving body 500. The pair of electrode portion 540A and the electrode portion 550A is provided at both ends of the main body portion 530A of the first moving body 500, and is arranged away from the cutting piece 420A. Therefore, since the pair of electrode portion 540A and electrode portion 550A are not physically or electrically connected to the to-be-cut portion 400A, the current flowing through the electrical circuit does not flow to the fuse functional circuit portion 800A via the electrode portion 540A and the electrode portion 550A. Therefore, it is possible to prevent the current from constantly flowing to the fuse functional circuit portion 800A side, and it is possible to improve the durability of the fuse functional circuit portion 800A and to suppress wasteful power consumption.

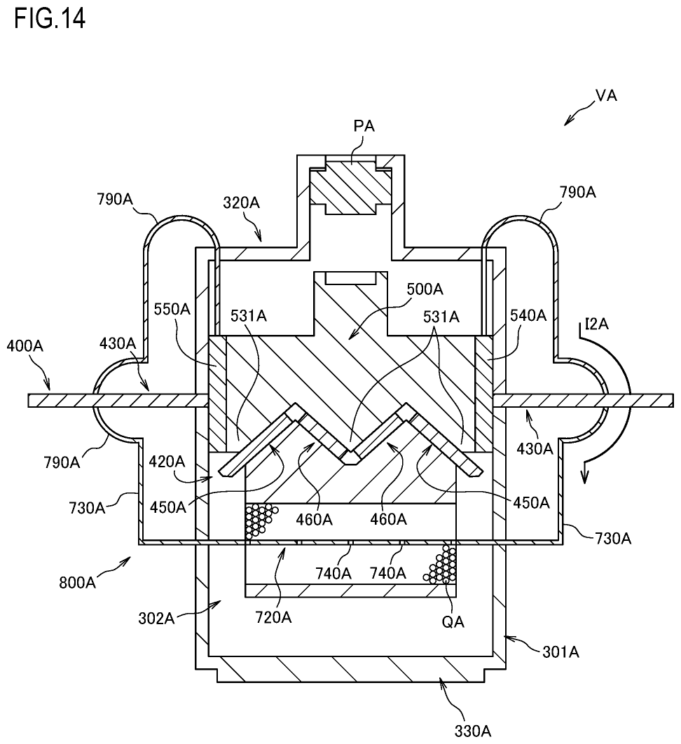

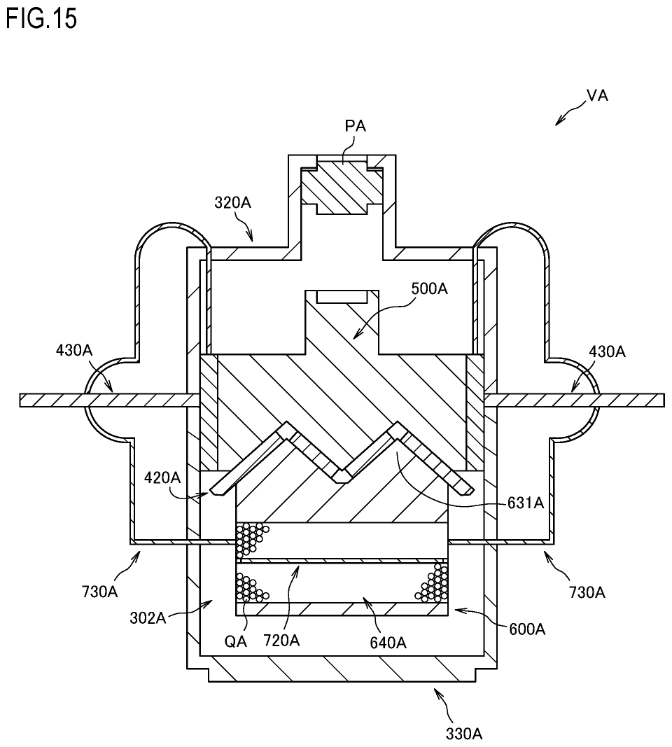

Next, a state in which the electrical circuit breaker device VA breaks the electrical circuit in a case where an abnormality such as overcurrent flowing through the electrical circuit is detected will be described with reference to FIGS. 14 and 15. FIG. 14 is a sectional view illustrating a state in which the first moving body 500A moves from the state illustrated in FIG. 13, and FIG. 15 is a sectional view illustrating a state in which the first moving body 500A further moves from the state illustrated in FIG. 14.

First, as illustrated in FIG. 14, in a case where an abnormality such as overcurrent flowing through the electrical circuit is detected, an abnormal signal is input to the power source PA, and the gunpowder in the power source PA explodes. Then, the first moving body 500A is vigorously blown away from the first end portion 320A toward the second end portion 330A by the air pressure due to the explosion, and instantaneously moves in the accommodating space 302A toward the second end portion 330A. Then, the cutting piece 420A is strongly pushed downward by the protruding portion 531A of the first moving body 500A. Then, the cutting piece 420A is divided at a plurality of places in a substantially M shape, and is physically cut off from the base pieces 430A on both sides. That is, the state is broken in which the base pieces 430A on both sides of the to-be-cut portion 400A are energized via the cutting piece 420A, and an overcurrent can be prevented from flowing through the electrical circuit.

Note that when the cutting piece 420A of the to-be-cut portion 400A is cut off by the first moving body 500A, the cutting piece 420A is divided into a plurality of places (specifically, each of the end portion separation pieces 450A and each of the intermediate separation pieces 460A) in a substantially M shape. Accordingly, in a case where an arc is slightly generated between the intermediate separation piece 460A and the end portion separation piece 450A when the cutting piece 420A is cut off, the arc can still be effectively and quickly extinguished. In particular, since the cutting piece 420A is cut off into a plurality of portions and separated, a high voltage dividing and current dividing effect can be obtained, the arc that can be generated when the cutting piece 420A is cut off can be extinguished more effectively and quickly.

Here, in a case where the abnormal current is a relatively large current, a large voltage is applied to the base pieces 430A on both sides connected to the electrical circuit. Therefore, after the cutting piece 420A is cut off, there is still a possibility that an arc continues to generate between the base pieces 430A and the cutting piece 420A which has been cut off. Here, as illustrated in FIG. 13, the lower end of the protruding portion 531A that cuts off the cutting piece 420A and the lower ends of the electrode portion 540A and the electrode portion 550A have the same height. That is, at the moment when the first moving body 500A moves toward the second end portion 330A side and the protruding portion 531A starts to cut off the cutting piece 420A, at the same time, the electrode portion 540A and the electrode portion 550A are in contact with a part of the to-be-cut portion 400A, and the to-be-cut portion 400A and the fuse functional circuit portion 800A are electrically connected via the electrode portion 540A and the electrode portion 550A. As illustrated in FIG. 14, during the first moving body 500A moving toward the second end portion 330A side and the cutting piece 420A is cut off, a state is kept in which the electrode portion 540A and the electrode portion 550A extending in the vertical direction (moving direction of the first moving body 500A) are always in contact with the base piece 430A, and the to-be-cut portion 400A and the fuse functional circuit portion 800A are electrically connected.

As described above, before the cutting piece 420A of the to-be-cut portion 400A is cut off, the base piece 430A of the to-be-cut portion 400A and the base piece 730A of the fuse functional circuit portion 800A are electrically connected via the pair of electrode portion 540A and the electrode portion 550A, and the connection member 790A. Therefore, when the cutting piece 420A is cut off, the fault current I2A flowing through the electrical circuit is induced to the fusion portion 740A of the cutting piece 720A via the base piece 730A. Therefore, it is possible to prevent the arc from being continuously generated between the divided cutting piece 420A and the base piece 430A.

As illustrated in FIG. 14, the fault current I2A induced to the fuse functional circuit portion 800A causes the fusion portion 740A to generate heat and fuse. Further, at the time of fusing the fusion portion 740A, an arc is generated around the fusion portion 740A by the voltage applied to the base pieces 730A on both sides connected to the electrical circuit, but the arc is quickly and effectively extinguished by the arc-extinguishing material QA filled around the fusion portion 740A.

Next, as illustrated in FIG. 15, after the cutting piece 420A is cut off, the first moving body 500A continuously moves in the accommodating space 302A from the first end portion 320A to the second end portion 330A. Then, the first moving body 500A abuts on the upper end side (the first end portion 320A side) of the second moving body 600A, and the first moving body 500A pushes out the second moving body 600A strongly toward the second end portion 330A side. The abutting portion 631 of the second moving body 600 has a substantially M shape in accordance with the shape of the lower surface side of the first moving body 500A.

Then, the cutting piece 720A inserted through the accommodating space 640A of the second moving body 600A is strongly pushed downward and divided by the second moving body 600A moving toward the second end portion 330A, and is physically cut off from the base pieces 730A on both sides. Since the accommodating space 640A is filled with the arc-extinguishing material QA, the pressing force by which the second moving body 600A is pushed out toward the second end portion 330A is effectively transmitted to the cutting piece 720A by the arc-extinguishing material QA surrounding the periphery of the cutting piece 720.

On the other hand, in a case where the abnormal current is a relatively low current, as illustrated in FIG. 14, when the cutting piece 420A is cut off, the fault current I2A flowing through the electrical circuit is induced to the fusion portion 740A of the fuse functional circuit portion 800A via the electrode portion 540A and the electrode portion 550A. Therefore, it is possible to prevent generation of an arc between the divided cutting piece 420A and the base piece 430A. However, in a case where the fault current I2A induced to the fuse functional circuit portion 800A belongs to a relatively low current range, there may be a case where the fusion portion 740A of the fuse functional circuit portion 800A is not fused and the current cannot be broken, or a case where it takes a relatively long time to break the current and the overcurrent flowing through the electrical circuit cannot be broken immediately.

However, as illustrated in FIG. 15, the second moving body 600A pushed out by the first moving body 500A cuts off the cutting piece 720A of the fuse functional circuit portion 800A and separates the cutting piece 720A from the base piece 730A. Therefore, in a case where the fusion portion 740A is not fused or it takes a relatively long time to break the current, it is still possible to immediately break the state in which the base pieces 730A on both sides of the fuse functional circuit portion 800A are energized via the cutting piece 720A, so as to prevent an overcurrent from flowing through the electrical circuit. In addition, in a case where an arc is generated between the cutting piece 720A and the base piece 730A when the cutting piece 720A is cut off, the arc is still effectively extinguished by the arc-extinguishing material QA in the accommodating space 640A through which the cutting piece 720A is inserted.

As described above, according to the electrical circuit breaker device VA of the present invention, in a case where an overcurrent belonging to a relatively low current range flows through the electrical circuit, as illustrated in FIG. 14, the first moving body 500A cuts off the cutting piece 420A of the to-be-cut portion 400A, and then, as illustrated in FIG. 15, the second moving body 600A cuts off the cutting piece 720A of the fuse functional circuit portion 800A, thereby preventing the overcurrent from flowing through the electrical circuit. On the other hand, in a case where an overcurrent belonging to a relatively large current range flows through the electrical circuit, as illustrated in FIG. 14, when the first moving body 500A cuts off the cutting piece 420A of the to-be-cut portion 400A, a fault current is induced to the fusion portion 740A of the fuse functional circuit portion 800A to be safely broken, thereby preventing the overcurrent from flowing through the electrical circuit. Thus, according to the electrical circuit breaker device VA of the present invention, a quick breaking capability is provided for a wide current range, including not only relatively high currents, but also relatively low currents.

### Third Embodiment

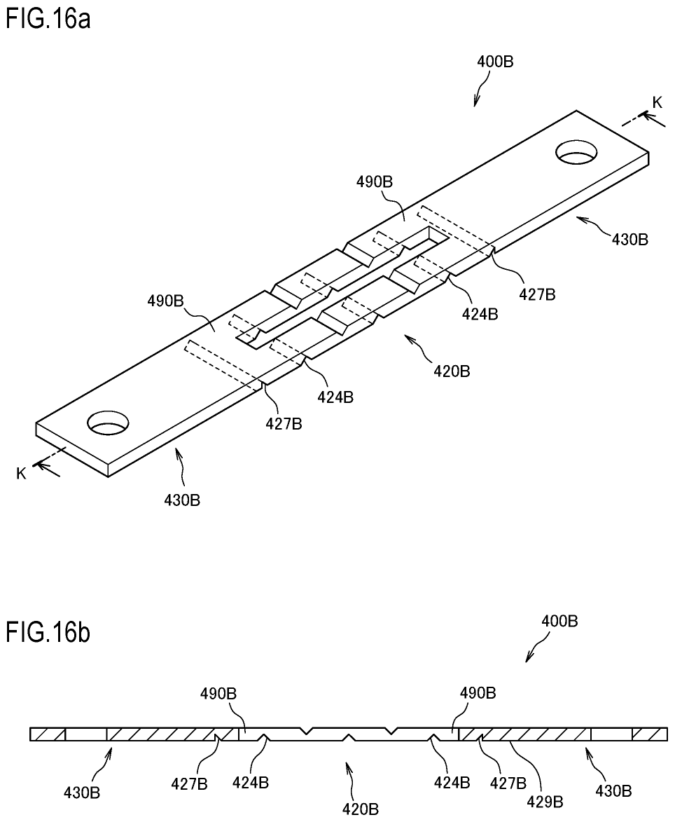

Next, an electrical circuit breaker device VB of the present invention according to the third embodiment will be described with reference to FIGS. 16 to 19. Since the configuration of the electrical circuit breaker device VB according to the third embodiment is basically the same as the configuration of the electrical circuit breaker device VA according to the second embodiment, the description of the same configuration is omitted. Note that FIG. 16(a) is a perspective view of a to-be-cut portion 400B constituting a part of an electrical circuit broken by the electrical circuit breaker device VB according to the third embodiment of the present invention, and FIG. 16(b) is a sectional view of the to-be-cut portion 400B taken along line K-K.

In the to-be-cut portion 400B illustrated in FIG. 16, in addition to the configuration of the to-be-cut portion 400A illustrated in FIG. 12, a cut 427B that is linear is provided on the back surface 429B of each boundary portion between the base piece 430B and the cutting piece 420B in a manner of traversing in the width direction of the to-be-cut portion 400B. The cut 427B facilitates bending of each boundary portion 490B between the base piece 430B and the cutting piece 420B. Then, as will be described later, when the cutting piece 420B is cut off by the first moving body 500B, the cutting piece 420B is cut off by the cut 424B and separated from the base piece 430B. On the other hand, the boundary portion 490B between the cutting piece 420B and the base piece 430B is bent by the cut 427B and remains coupled to the base piece 430B.

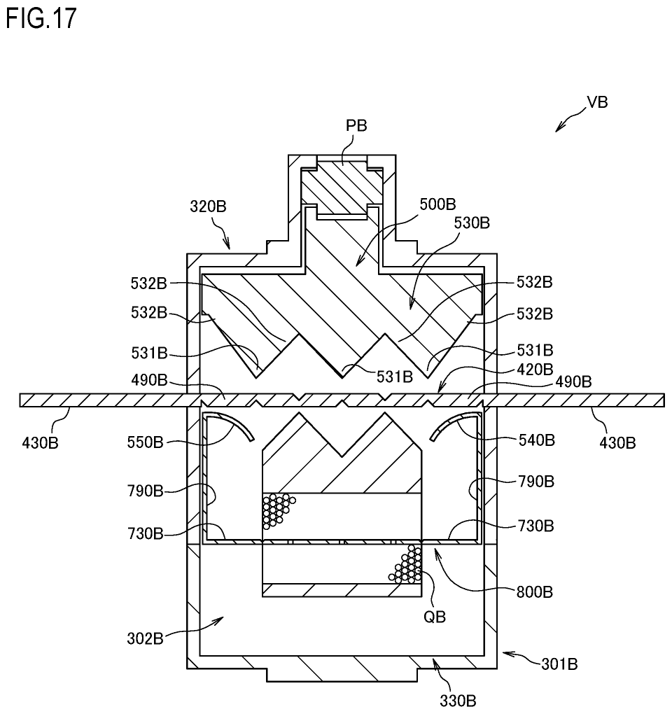

Next, an internal structure of the electrical circuit breaker device VB according to the third embodiment of the present invention will be described with reference to FIG. 17. Note that similar to FIG. 9, FIG. 17 is a sectional view of the electrical circuit breaker device VB according to the second embodiment in an assembled state.

As illustrated in FIG. 17, the first moving body 500B is accommodated in the accommodating space 302B, and is configured to be movable from the first end portion 320B toward the second end portion 330B of the housing 301A. The lower end side of the main body portion 530B of the first moving body 500B includes a protruding portion 531B protruding downward and a recess portion 532B recessed upward from the protruding portion 531B. Three protruding portion 531B are provided on the lower end side of the main body portion 530B, and a total of four recess portion 532B are provided alternately with the protruding portions 531B. Therefore, the lower end side of the main body portion 530B has a concavo-convex shape in which a mountain and a valley are continuous by the protruding portions 531B and the recess portions 532B. Then, as will be described later, the portion having a concavo-convex shape abuts on the cutting piece 420B of the to-be-cut portion 400B and applies a pressing force to cut off the cutting piece 420B.

As illustrated in FIG. 17, before the electrical circuit breaker device VB operates, that is, before the first moving body 500B moves and the cutting piece 420B of the to-be-cut portion 400B starts to be cut off, the to-be-cut portion 400B and the fuse functional circuit portion 800B are not electrically or physically connected to each other. A connection member 790B made of a conductor is coupled to each of the base pieces 730B of the fuse functional circuit portion 800B, and each connection member 790B is not connected to the to-be-cut portion 400B but is electrically connected to the electrode portion 540B and the electrode portion 550B. The pair of electrode portion 540B and electrode portion 550B is provided on the opposite side of the first moving body 500B with the cutting piece 420B interposed therebetween, and is arranged away from the cutting piece 420B. Therefore, since the pair of electrode portion 540B and electrode portion 550B is not physically or electrically connected to the to-be-cut portion 400B, the current flowing through the electrical circuit does not flow to the fuse functional circuit portion 800B via the electrode portion 540B and the electrode portion 550B. Therefore, it is possible to prevent the current from constantly flowing to the circuit portion 700B side, and it is possible to improve the durability of the fuse functional circuit portion 800B and to suppress wasteful power consumption.

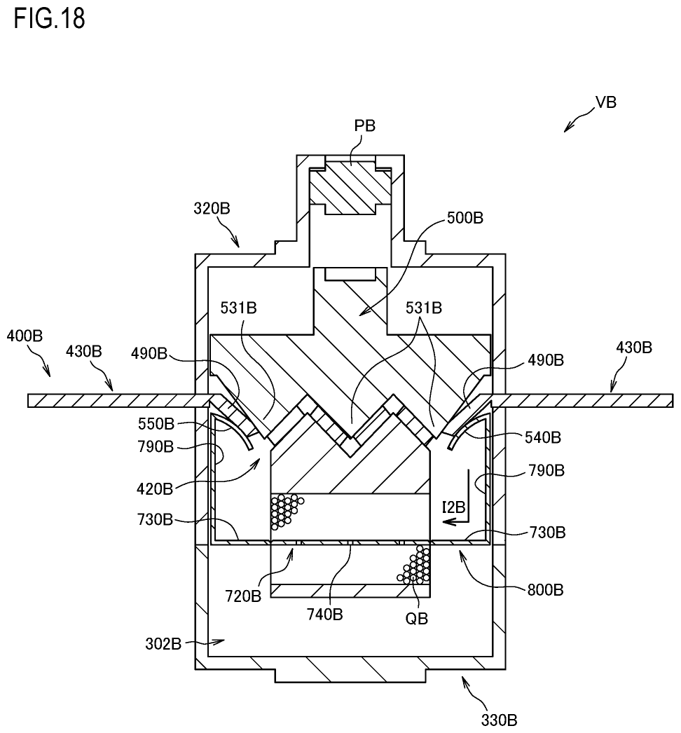

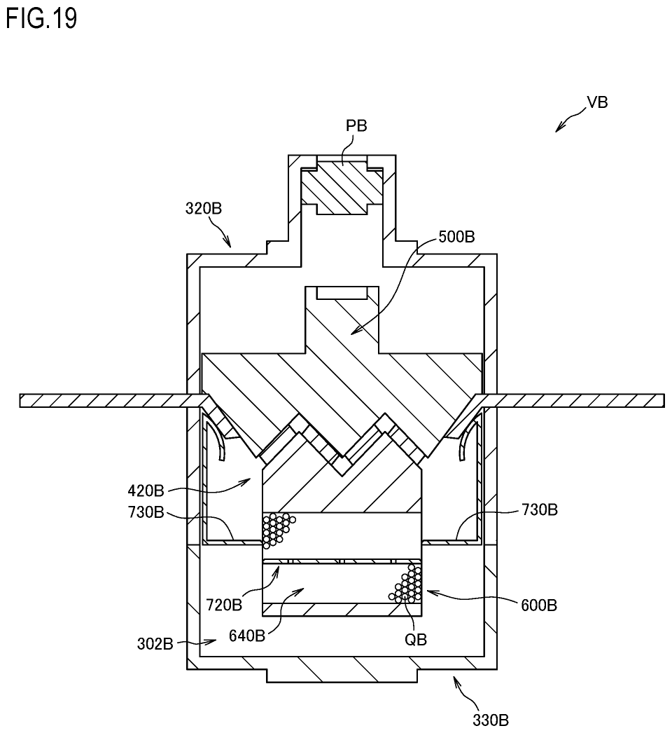

Next, a state in which the electrical circuit breaker device VB breaks the electrical circuit in a case where an abnormality such as overcurrent flowing through the electrical circuit is detected will be described with reference to FIGS. 18 and 19. Note that FIG. 18 is a sectional view illustrating a state in which the first moving body 500B moves from the state illustrated in FIG. 17, and FIG. 19 is a sectional view illustrating a state in which the first moving body 500B further moves from the state illustrated in FIG. 18.

First, as illustrated in FIG. 18, in a case where an abnormality such as overcurrent flowing through the electrical circuit is detected, an abnormal signal is input to the power source PB, and the gunpowder in the power source PB explodes. Then, the first moving body 500B is vigorously blown away from the first end portion 320B toward the second end portion 330B by the air pressure due to the explosion, and instantaneously moves in the accommodating space 302B toward the second end portion 330B. Then, the cutting piece 420B is strongly pushed downward by the protruding portion 531B of the first moving body 500B. Then, the cutting piece 420B is divided at a plurality of places in a substantially M shape, and is physically cut off from the base pieces 430B on both sides. That is, the state is broken in which the base pieces 430B on both sides of the to-be-cut portion 400B are energized via the cutting piece 420B, and an overcurrent can be prevented from flowing through the electrical circuit.

Here, in a case where the abnormal current is a relatively large current, a large voltage is applied to the base pieces 430B on both sides connected to the electrical circuit. Therefore, after the cutting piece 420B is cut off, there is still a possibility that an arc continues to generate between the base pieces 430B and the cutting piece 420B which has been cut off. Here, as illustrated in FIG. 17, the electrode portion 540B and the electrode portion 550B are not in contact with the boundary portion 490B of the to-be-cut portion 400B, but are arranged close to each other. Then, at the moment when the first moving body 500B moves toward the second end portion 330B side and the protruding portion 531B starts to cut off the cutting piece 420B, the electrode portion 540B and the electrode portion 550B come into contact with the periphery of the boundary portion 490B which is a part of the to-be-cut portion 400B since the vicinity of the boundary portion 490B is pressed downward by the protruding portion 531B and bent downward. Therefore, the to-be-cut portion 400B and the fuse functional circuit portion 800B are electrically connected via the electrode portion 540B and the electrode portion 550B. As illustrated in FIG. 18, during the first moving body 500B moving toward the second end portion 330B side and the cutting piece 420B being cut off, the boundary portion 490B is bent downward but remains connected to the base piece 430B. Therefore, the electrode portion 540B and electrode portion 550B are always in contact with the boundary portion 490B, and the to-be-cut portion 400B and the fuse functional circuit portion 800B are kept electrically connected.

As described above, before the cutting piece 420B of the to-be-cut portion 400B is cut off, the base piece 430B of the to-be-cut portion 400B and the base piece 730B of the fuse functional circuit portion 800B are electrically connected via the pair of electrode portion 540B and the electrode portion 550B, and the connection member 790B. Therefore, when the cutting piece 420B is cut off, the fault current I2B flowing through the electrical circuit is induced to the fusion portion 740B of the fuse functional circuit portion 800B via the base piece 730B. Therefore, it is possible to prevent the arc from being continuously generated between the divided cutting piece 420B and the base piece 430B.

As illustrated in FIG. 18, the fault current I2B induced to the fuse functional circuit portion 800B causes the fusion portion 740B of the fuse functional circuit portion 800B to generate heat and fuse. Further, at the time of fusing the fusion portion 740B, an arc is generated around the fusion portion 740B by the voltage applied to the base pieces 730B on both sides connected to the electrical circuit, but the arc is quickly and effectively extinguished by the arc-extinguishing material QB filled around the fusion portion 740B.

Next, as illustrated in FIG. 19, after the cutting piece 420B is cut off, the first moving body 500B continuously moves in the accommodating space 302B from the first end portion 320B to the second end portion 330B. Then, the first moving body 500B abuts on the upper end side (the first end portion 320B side) of the second moving body 600B, and the first moving body 500B pushes out the second moving body 600B strongly toward the second end portion 330B side. Then, the cutting piece 720B inserted through the accommodating space 640B of the second moving body 600B is strongly pushed downward and divided by the second moving body 600B moving toward the second end portion 330B, and is physically cut off from the base pieces 730B on both sides. Since the accommodating space 640B is filled with the arc-extinguishing material QB, the pressing force by which the second moving body 600B is pushed out toward the second end portion 330B is effectively transmitted to the cutting piece 720B by the arc-extinguishing material QB surrounding the periphery of the cutting piece 720B.

On the other hand, in a case where the abnormal current is a relatively low current, as illustrated in FIG. 18, when the cutting piece 420B is cut off, the fault current I2B flowing through the electrical circuit is induced to the fusion portion 740B of the fuse functional circuit portion 800B via the electrode portion 540B and the electrode portion 550B. Therefore, it is possible to prevent generation of an arc between the divided cutting piece 420B and the base piece 430B. However, in a case where the fault current I2B induced to the fuse functional circuit portion 800B belongs to a relatively low current range, there may be a case where the fusion portion 740B of the fuse functional circuit portion 800B is not fused and the current cannot be broken, or a case where it takes a relatively long time to break the current and the overcurrent flowing through the electrical circuit cannot be broken immediately.

However, as illustrated in FIG. 19, the second moving body 600B pushed out by the first moving body 500B cuts off the cutting piece 720B of the fuse functional circuit portion 800B and separates the cutting piece 720B from the base piece 730B. Therefore, in a case where the fusion portion 740B is not fused or it takes a relatively long time to break the current, it is still possible to immediately break the state in which the base pieces 730B on both sides of the fuse functional circuit portion 800B are energized via the cutting piece 720B, so as to prevent an overcurrent from flowing through the electrical circuit. In addition, in a case where an arc is generated between the cutting piece 720B and the base piece 730B when the cutting piece 720B is cut off, the arc is still effectively extinguished by the arc-extinguishing material QB in the accommodating space 640B through which the cutting piece 720B is inserted.

As described above, according to the electrical circuit breaker device VB of the present invention, in a case where an overcurrent belonging to a relatively low current range flows through the electrical circuit, as illustrated in FIG. 18, the first moving body 500B cuts off the cutting piece 420B of the to-be-cut portion 400B, and then, as illustrated in FIG. 19, the second moving body 600B cuts off the cutting piece 720B of the fuse functional circuit portion 800B, thereby preventing the overcurrent from flowing through the electrical circuit. On the other hand, in a case where an overcurrent belonging to a relatively large current range flows through the electrical circuit, as illustrated in FIG. 18, when the first moving body 500B cuts off the cutting piece 420B of the to-be-cut portion 400B, a fault current is induced to the fusion portion 740B of the fuse functional circuit portion 800B to be safely broken, thereby preventing the overcurrent from flowing through the electrical circuit. Thus, according to the electrical circuit breaker device VB of the present invention, a quick breaking capability is provided for a wide current range, including not only relatively high currents, but also relatively low currents.

### Fourth Embodiment

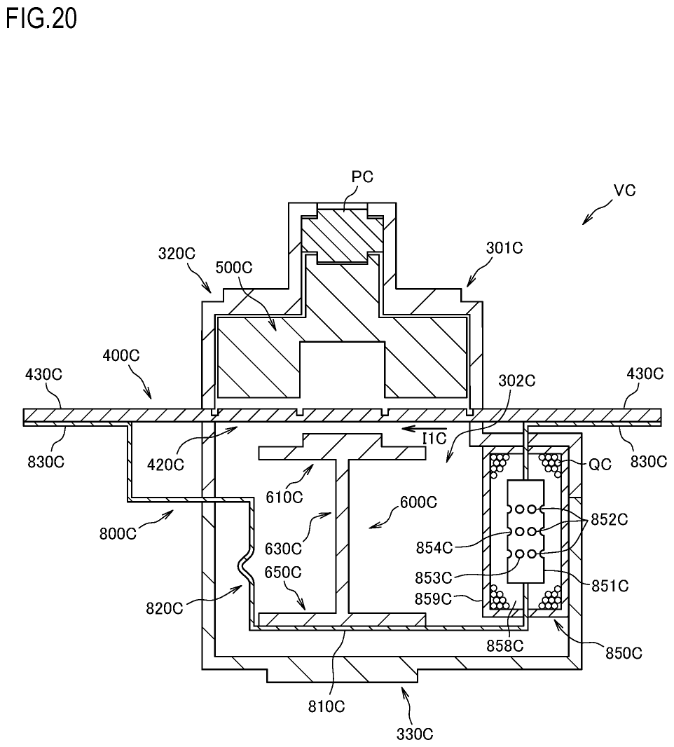

Next, an electrical circuit breaker device VC of the present invention according to the fourth embodiment will be described with reference to FIGS. 20 to 22. Further, the configuration of the electrical circuit breaker device VC according to the fourth embodiment is different from the configuration of the electrical circuit breaker device V according to the first embodiment in the configuration of the second moving body 600C and the fuse functional circuit portion 800C. The other configurations are basically the same as the configuration of the electrical circuit breaker device V according to the first embodiment, and thus the description of the same configurations is omitted. Note that similar to FIG. 9, FIG. 20 is a sectional view of the electrical circuit breaker device VC according to the fourth embodiment in an assembled state.

As illustrated in FIG. 20, the fuse functional circuit portion 800C includes base pieces 830C on both sides connected to the base piece 430C and a connection portion 810C connecting the base pieces 830C on both sides, and is entirely made of a metal conductor such as copper in order to be electrically connected to the electrical circuit and the to-be-cut portion 400C. The fuse functional circuit portion 800C includes a fuse portion 850C between the connection portion 810C and the base piece 830C. The fuse portion 850C includes an element 851C made of a metal conductor, a plurality of fusion portion 852C in the element 851C, and a casing 859C that accommodates the element 851C. The fusion portion 852C includes a narrow portion 854C whose width is locally narrowed by a plurality of through holes 853C provided in the element 851C, and the narrow portion 854C generates heat and fuses to break the current when an abnormal current flows.

In the accommodating space 858C inside the casing 859C, the arc-extinguishing material QC is housed in a manner of surrounding the element 851C including the fusion portion 852C. The accommodating space 302C in the housing 301C of the electrical circuit breaker device VC and the accommodating space 858C of the fuse portion 850C of the fuse functional circuit portion 800C are isolated from each other by the casing 859C of the fuse portion 850C, and the accommodating space 858C accommodating the arc-extinguishing material QC of the fuse functional circuit portion 800C and the accommodating space 302C accommodating the first moving body 500C and the second moving body 600C are separate spaces isolated from each other. That is, although the first moving body 500C and the second moving body 600C move in the accommodating space 302C of the housing 301C from the first end portion 320C toward the second end portion 330C, since the accommodating space 858C of the fuse functional circuit portion 800C does not exist in the movement range of the first moving body 500C and the second moving body 600C, the arc-extinguishing material QC in the accommodating space 858C does not interfere with the first moving body 500C and the second moving body 600C, and does not hinder the movement of the first moving body 500C and the second moving body 600C.

The connection portion 810C is provided with a deformable connection portion 820C. As illustrated in FIG. 20, before the electrical circuit breaker device VC operates, that is, before the first moving body 500C moves and the cutting piece 420C of the to-be-cut portion 400C starts to be cut off, the deformable connection portion 820C is bent in a substantially V-shape, and as will be described later, as the second moving body 600C moves downward, the deformable connection portion 820C is elastically deformed in such a manner that the substantially V-shape shape portion opens linearly and extends. The deformable connection portion 820C is configured to be deformable by bending an elastically deformable conductor into a substantially V-shape, and is not limited thereto, and may have any configuration as long as the deformable connection portion 820C can be deformed toward the second end portion 330C as the second moving body 600C moves downward so as not to hinder the movement of the second moving body 600C, such as an elastically deformable conductor wound in a coil shape or an electric wire having a margin in length.

In addition, the second moving body 600C has the same shape on the upper end portion 610C side as the second moving body 600 illustrated in FIG. 5, but does not include the accommodating space 640 in the main body portion 630C. A lower end portion 650C on an opposite side of the upper end portion 610C is a flat surface that abuts on the connection portion 810C. The lower end portion 650C of the second moving body 600C abuts on the connection portion 810C, but is not fixed to the connection portion 810C and is in an independent state. Therefore, the second moving body 600C and the fuse functional circuit portion 800C can be easily assembled.

Then, as illustrated in FIG. 20, the electrical circuit breaker device VC is used by being attached in an electrical circuit to be protected. Specifically, the base piece 430C of the to-be-cut portion 400C and the base piece 830C of the fuse functional circuit portion 800C are connected to a part of the electrical circuit, and the to-be-cut portion 400C and the fuse functional circuit portion 800C are connected in parallel so as to constitute a part of the electrical circuit. In the normal state (that is, when no abnormal current flows), since the base piece 430C and the cutting piece 420C of the to-be-cut portion 400C are not cut off and are physically and electrically connected, the current I1C flows through the electrical circuit via the base piece 430C and the cutting piece 420C of the to-be-cut portion 400C.

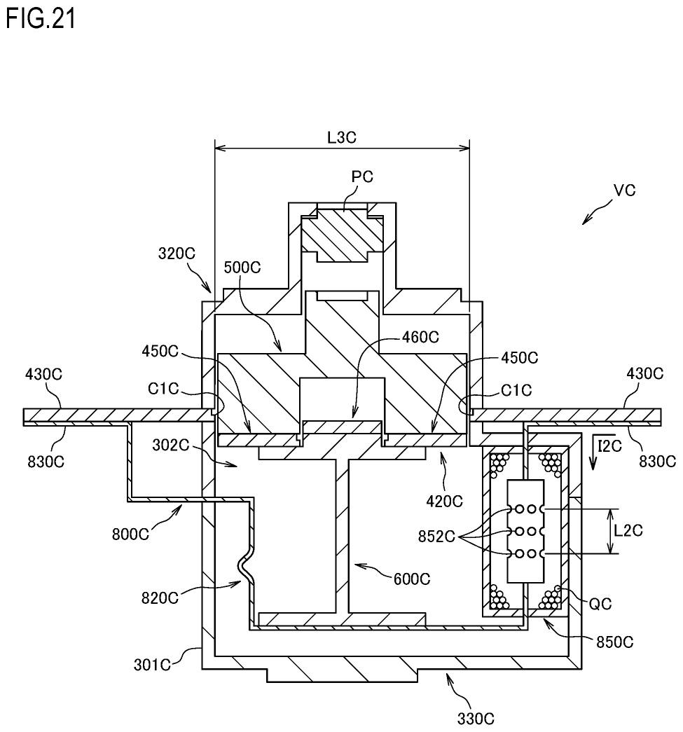

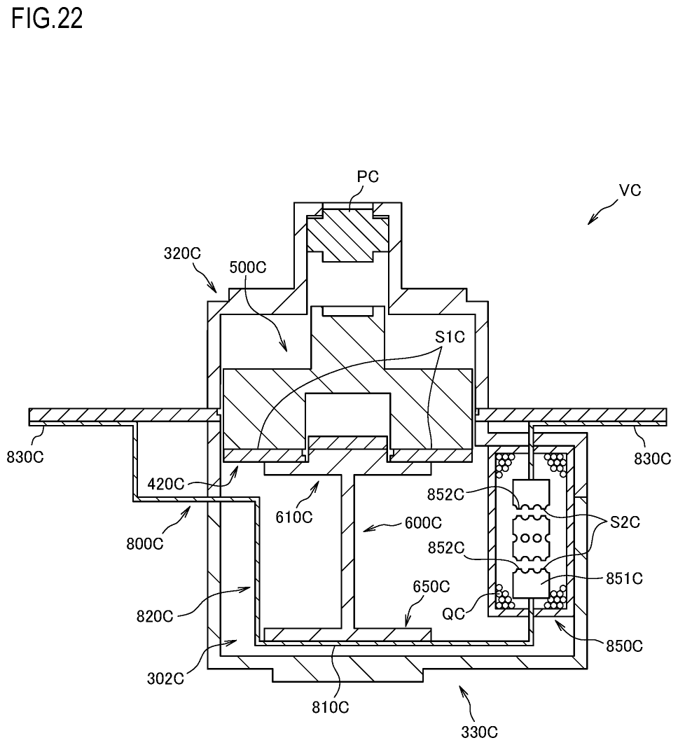

Next, a state in which the electrical circuit breaker device VC breaks the electrical circuit in a case where an abnormality such as overcurrent flowing through the electrical circuit is detected will be described with reference to FIGS. 21 and 22. Note that FIG. 21 is a sectional view illustrating a state in which the first moving body 500C moves from the state illustrated in FIG. 20, and FIG. 22 is a sectional view illustrating a state in which the first moving body 500C further moves from the state illustrated in FIG. 21.

First, as illustrated in FIG. 21, in a case where an abnormality such as overcurrent flowing through the electrical circuit is detected, an abnormal signal is input to the power source PC, and the gunpowder in the power source PC explodes. Then, the first moving body 500C is vigorously blown away from the first end portion 320C toward the second end portion 330C by the air pressure, and instantaneously moves in the accommodating space 302C toward the second end portion 330C. Then, the cutting piece 420 is strongly pushed downward and divided by the first moving body 500C, and the base pieces 430C on both sides are physically cut off. That is, the state is broken in which the base pieces 430C on both sides of the to-be-cut portion 400C are energized via the cutting piece 420C, and an overcurrent can be prevented from flowing through the electrical circuit.

Here, in a case where the abnormal current is a relatively large current, a large voltage is applied to the base pieces 430C on both sides connected to the electrical circuit. Therefore, after the cutting piece 420C is cut off, there is still a possibility that an arc continues to generate between the base pieces 430C and the cutting piece 420C which has been cut off. However, as illustrated in FIG. 20, before the cutting piece 420C of to-be-cut portion 400C is cut off, the base piece 430C of to-be-cut portion 400C and the base piece 830C of the fuse functional circuit portion 800C are electrically connected. When the cutting piece 420C is cut off, as illustrated in FIG. 21, the fault current I2C flowing through the electrical circuit is induced to the fuse portion 850C of the fuse functional circuit portion 800C through the base piece 830C. Therefore, it is possible to prevent the arc from being continuously generated between the divided cutting piece 420C and the base piece 430C.

As illustrated in FIG. 21, the fault current I2C induced to the fuse portion 850C causes the fusion portion 852C of the fuse portion 850C to generate heat and fuse. Note that when the cutting piece 420C is cut off by the first moving body 500C to break the electrical circuit, the fault current I2C is induced to the fuse portion 850C, and the current flows through the electrical circuit. Therefore, strictly speaking, the electrical circuit is not completely broken. However, since the rating of the fusion portion 852C of the fuse portion 850C is reduced, the fusion portion 852C is immediately fused by the fault current I2C, and the electrical circuit is immediately completely broken. Further, at the time of fusing the fusion portion 852C, an arc is generated around the fusion portion 852C by the voltage applied to the base pieces 830C on both sides connected to the electrical circuit, but the arc is quickly and effectively extinguished by the arc-extinguishing material QC filled around the fusion portion 852C.

As described above, according to the electrical circuit breaker device VC of the present invention, since the to-be-cut portion 400C and the fuse functional circuit portion 800C are connected before the state is broken in which the to-be-cut portion 400C is energized and the arc due to the fault current is generated between the base pieces 430C on both sides, the arc due to the fault current can be reliably induced to the fuse functional circuit portion 800C and extinguished by the fusion portion 852C and the arc-extinguishing material QC of the fuse functional circuit portion 800C. As a result, in the housing 301C, it is possible to prevent the electrical circuit breaker device VC from being damaged by generation of an arc due to a fault current between the base pieces 430C, and to safely break the electrical circuit.

Next, as illustrated in FIG. 22, after the cutting piece 420C is cut off, the first moving body 500C continuously moves in the accommodating space 302C from the first end portion 320C to the second end portion 330C. Then, the first moving body 500C abuts on the upper end portion 610C side (the first end portion 320C side) of the second moving body 600C, and the first moving body 500C pushes out the second moving body 600C strongly toward the second end portion 330C side.

Then, the lower end portion 650C of the second moving body 600C strongly abuts on the connection portion 810C of the fuse functional circuit portion 800C and pushes out the connection portion 810C toward the second end portion 330C side. Due to the pressing force, the connection portion 810C of the fuse functional circuit portion 800C is strongly pushed downward, and the element 851C of the fuse portion 850C coupled to one side of the connection portion 810C is also strongly pulled downward. Then, the fusion portion 852C is vertically divided, and the base pieces 830C on both sides are physically cut off. Note that in a case where the abnormal current is a relatively large current, as illustrated in FIG. 21, the fusion portion 852C is fused to break the electrical circuit. Here, as illustrated in FIG. 22, after the fusion portion 852C is fused and the electrical circuit is broken, the electrical circuit is physically and more reliably broken by cutting off a part of the element 851C. The length between the cutting portions of the fusion portion 852C of the fuse functional circuit portion 800C is L2C.

As the second moving body 600C moves downward, the deformable connection portion 820C is elastically deformed in such a manner that the substantially V-shape portion opens linearly. Therefore, the deformable connection portion 820C does not hinder the movement of the second moving body 600C. When a part of the fuse functional circuit portion 800C is pushed out by the second moving body 600C, the deformable connection portion 820C is deformed and not cut off, and therefore only the fusion portion 852C side can be reliably cut off, and an arc that may be generated at the cutting portion can be reliably and safely extinguished by the arc-extinguishing material QC around the fusion portion 852C.

On the other hand, in a case where the abnormal current is a relatively low current, as illustrated in FIG. 21, when the cutting piece 420C is cut off, the fault current I2C flowing through the electrical circuit is induced to the fusion portion 852C of the fuse functional circuit portion 800C via the base piece 830C. Therefore, it is possible to prevent generation of an arc between the divided cutting piece 420C and the base piece 430C.

However, in a case where the fault current I2C induced to the fusion portion 852C of the fuse functional circuit portion 800C belongs to a relatively low current range, there may be a case where the fusion portion 852C of the fuse functional circuit portion 800C is not fused and the current cannot be broken, or a case where it takes a relatively long time to break the current and the overcurrent flowing through the electrical circuit cannot be broken immediately.

However, as illustrated in FIG. 22, the second moving body 600C pushed out by the first moving body 500C cuts off the fusion portion 852C of the fuse functional circuit portion 800C. Therefore, in a case where the fusion portion 852C is not fused or it takes a relatively long time to break the current, it is still possible to immediately break the state that is energized via the fuse functional circuit portion 800C, so as to prevent an overcurrent from flowing through the electrical circuit. Further, in a case where an arc is generated around the fusion portion 852C when the fusion portion 852C is cut off, the arc is still effectively extinguished by the arc-extinguishing material QC around the fusion portion 852C.

As described above, according to the electrical circuit breaker device VC of the present invention, in a case where an overcurrent belonging to a relatively low current range flows through the electrical circuit, as illustrated in FIG. 21, the first moving body 500C cuts off the cutting piece 420C of the to-be-cut portion 400C, and then, as illustrated in FIG. 22, the second moving body 600C cuts off the fusion portion 852C of the fuse functional circuit portion 800C, thereby preventing the overcurrent from flowing through the electrical circuit. On the other hand, in a case where an overcurrent belonging to a relatively large current range flows through the electrical circuit, as illustrated in FIG. 21, when the first moving body 500C cuts off the cutting piece 420C of the to-be-cut portion 400C, a fault current is induced to the fusion portion 852C of the fuse functional circuit portion 800C to be safely broken, thereby preventing the overcurrent from flowing through the electrical circuit. Thus, according to the electrical circuit breaker device VC of the present invention, a quick breaking capability is provided for a wide current range, including not only relatively high currents, but also relatively low currents.

In addition, since the first moving body 500C and the second moving body 600C are configured to be individually movable, the timing of movement of the first moving body 500C and the second moving body 600C can be easily adjusted, and the configurations of the first moving body 500C and the second moving body 600C can be simplified. For example, when the distance between the first moving body 500C and the second moving body 600C is appropriately changed, it is easy to adjust the cutting off timing of the cutting piece 420C and the fusion portion 852C of the fuse functional circuit portion 800C according to the magnitude of the abnormal current to be broken or the like.

In the electrical circuit breaker device VC according to the present invention, as illustrated in FIGS. 21 and 22, the length L2C between the cutting portions on both sides of the fusion portion 852C of the fuse functional circuit portion 800C is shorter than the length L3C between the cutting portions C1C of the cutting piece 420C and each of the base pieces 430C of the to-be-cut portion 400C. That is, the cutting length L2C when the fusion portion 852C of the fuse functional circuit portion 800C is cut off by the second moving body 600C is shorter than the cutting length L3C when the cutting piece 420C is cut off by the first moving body 500C. Further, the cutting length L2C when the fusion portion 852C of the fuse functional circuit portion 800C is cut off by the second moving body 600C may be equal to the cutting length L3C when the cutting piece 420C is cut off by the first moving body 500C. As described above, when the cutting length L2C when the fusion portion 852C of the fuse functional circuit portion 800C is cut off by the second moving body 600C is equal to or less than the cutting length L3C when the cutting piece 420C is cut off by the first moving body 500C, that is, the relationship of length L2C≤length L3C is satisfied, the power of the first moving body 500C when the cutting piece 420C is cut off by the first moving body 500C is effectively transmitted in a manner of not being concentrated or attenuated to the second moving body 600 where the cutting length is short or equal, and the fusion portion 852C of the fuse functional circuit portion 800C can be quickly and reliably cut off. Since the power of the power source PC can be efficiently transmitted, the power source PC can be reduced by decreasing the amount of gunpowder or the like, which contributes to the downsizing and lightweighting of the housing 301C.

In addition, in the electrical circuit breaker device VC of the present invention, as illustrated in FIG. 4, when the first moving body 500C cuts off the cutting piece 420C, the area of a portion is S1C where the first moving body 500C comes into contact with the cutting piece 420C and applies a pressing force. As illustrated in FIG. 22, when the second moving body 600C cuts off the fusion portion 852C of the fuse functional circuit portion 800C, the sum of the area of the portion, where the fusion portion 852C of the fuse functional circuit portion 800C is cut off, is S2C. The area S2C where the fusion portion 852C of the fuse functional circuit portion 800C is cut off by the second moving body 600C is smaller than the area S1C where the cutting piece 420C is cut off by the first moving body 500C. Alternatively, the area S2C where the fusion portion 852C of the fuse functional circuit portion 800C is cut off by the second moving body 600C may be equal to the area S1C where the cutting piece 420C is cut off by the first moving body 500C. As described above, when the area S2C where the fusion portion 852C of the fuse functional circuit portion 800C is cut off by the second moving body 600C is equal to or smaller than the area S1C where the cutting piece 420C is cut off by the first moving body 500C, that is, the relationship of area S2C≤area S1C is satisfied, the power of the first moving body 500C when the cutting piece 420C is cut off by the first moving body 500C is effectively transmitted in a manner of not being concentrated or attenuated to the cutting portion where the cutting area of the second moving body 600C is small or equal, and the fusion portion 852C of the fuse functional circuit portion 800C can be quickly and reliably cut off. Since the power of the power source PC can be efficiently transmitted, the power source PC can be reduced by decreasing the amount of gunpowder or the like, which contributes to the downsizing and lightweighting of the housing 301C.

Note that the electrical circuit breaker device VC of the present invention is configured in such a manner that the relationship of length L2C≤length L3C and the relationship of area S2C≤area S1C are simultaneously established, and the present invention is not limited thereto, and only one of the relationship of length L2C≤length L3C and the relationship of area S2C≤area S1C may be established.

### Fifth Embodiment

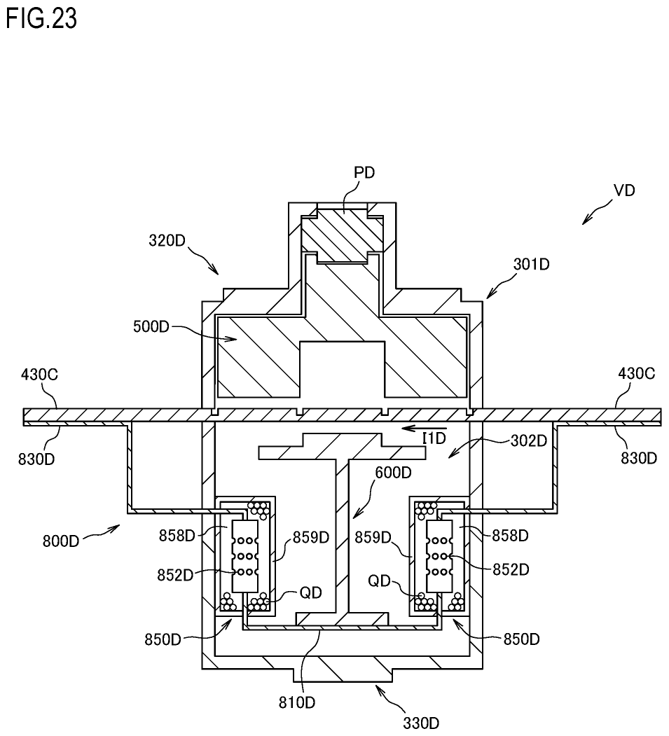

Next, an electrical circuit breaker device VD of the present invention according to the fifth embodiment will be described with reference to FIGS. 23 to 25. Further, the configuration of the electrical circuit breaker device VD according to the fifth embodiment is different from the configuration of the electrical circuit breaker device VC according to the fourth embodiment in the configuration of the fuse functional circuit portion 800D. The other configurations are basically the same as the configuration of the electrical circuit breaker device VC according to the fourth embodiment, and thus the description of the same configurations is omitted. Note that similar to FIG. 20, FIG. 23 is a sectional view of the electrical circuit breaker device VD according to the fifth embodiment in an assembled state.

As illustrated in FIG. 23, the fuse functional circuit portion 800D basically has the same configuration as the fuse functional circuit portion 800C illustrated in FIG. 20, but is different in that a fuse portion 850D is provided instead of the deformable connection portion 820C. That is, the fuse functional circuit portion 800D includes two fuse portions 850D. Specifically, the fuse portion 850D is connected between the connection portion 810D and one base piece 830D, the fuse portion 850D is also connected between the connection portion 810D and the other base piece 830D, and the fuse portion 850D is connected to both sides of the connection portion 810D pushed out by the second moving body 600D. Note that, the lower end portion of the second moving body 600D abuts on the connection portion 810D, but is not fixed to the connection portion 810D and is independent. Therefore, the second moving body 600D and the fuse functional circuit portion 800D can be easily assembled.

An arc-extinguishing material QD is housed in the accommodating space 858D inside the casing 859D of each of the fuse portion 850D on both sides in a manner of surrounding the periphery of the fusion portion 852D. The accommodating space 302D in the housing 301D of the electrical circuit breaker device VD and the accommodating space 858D of the fuse portion 850D of each of the fuse functional circuit portion 800D on both sides are isolated from each other by the casing 859D of the fuse portion 850D, and the accommodating space 858D accommodating the arc-extinguishing material QD of the fuse functional circuit portion 800D and the accommodating space 302D accommodating the first moving body 500D and the second moving body 600D are separate spaces isolated from each other. That is, although the first moving body 500D and the second moving body 600D move in the accommodating space 302D of the housing 301D from the first end portion 320D toward the second end portion 330D, since the accommodating space 858D of the fuse functional circuit portion 800D does not exist in the movement range of the first moving body 500D and the second moving body 600D, the arc-extinguishing material QD in the accommodating space 858D does not interfere with the first moving body 500D and the second moving body 600D, and does not hinder the movement of the first moving body 500D and the second moving body 600D.

Then, as illustrated in FIG. 23, the electrical circuit breaker device VD is used by being attached in an electrical circuit to be protected. Specifically, the base piece 430D of the to-be-cut portion 400D and the base piece 830D of the fuse functional circuit portion 800D are connected to a part of the electrical circuit, and the to-be-cut portion 400D and the fuse functional circuit portion 800D are connected in parallel so as to constitute a part of the electrical circuit. In the normal state (that is, when no abnormal current flows), since the base piece 430D and the cutting piece 420D of the to-be-cut portion 400D are not cut off and are physically and electrically connected, the current I1D flows through the electrical circuit via the base piece 430D and the cutting piece 420D of the to-be-cut portion 400D.

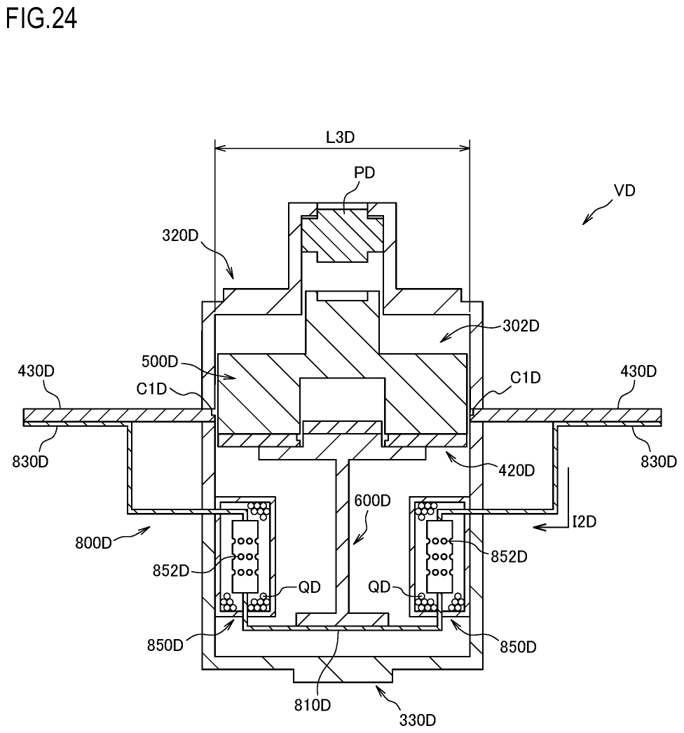

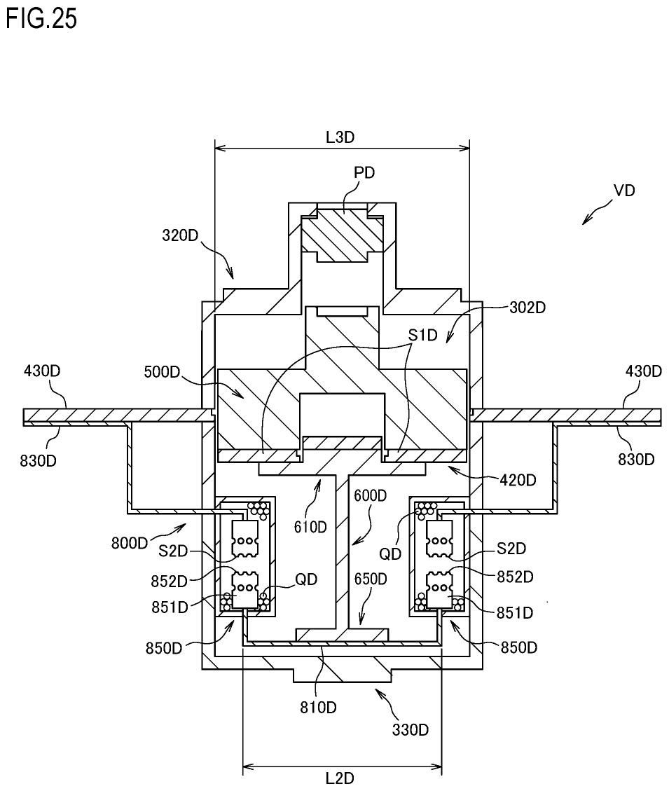

Next, a state in which the electrical circuit breaker device VD breaks the electrical circuit in a case where an abnormality such as overcurrent flowing through the electrical circuit is detected will be described with reference to FIGS. 24 and 25. Note that FIG. 24 is a sectional view illustrating a state in which the first moving body 500D moves from the state illustrated in FIG. 23, and FIG. 25 is a sectional view illustrating a state in which the first moving body 500D further moves from the state illustrated in FIG. 24.

First, as illustrated in FIG. 24, in a case where an abnormality such as overcurrent flowing through the electrical circuit is detected, an abnormal signal is input to the power source PD, and the gunpowder in the power source PD explodes. Then, by the air pressure, the first moving body 500D instantaneously moves in the accommodating space 302D toward the second end portion 330D, and strongly pushes the cutting piece 420D downward to divide the cutting piece 420D. Then, the state is broken in which the base pieces 430D on both sides of the to-be-cut portion 400D are energized via the cutting piece 420D, and an overcurrent can be prevented from flowing through the electrical circuit.

Here, in a case where the abnormal current is a relatively large current, after the cutting piece 420D is cut off, there is still a possibility that an arc continues to generate between the base pieces 430D and the cutting piece 420D which has been cut off. However, as illustrated in FIG. 24, since the base piece 430D of the to-be-cut portion 400D and the base piece 830D of the fuse functional circuit portion 800D are electrically connected before the cutting piece 420D of the to-be-cut portion 400D is cut off, when the cutting piece 420D is cut off, the fault current I2D flowing through the electrical circuit is induced to the fuse portion 850D of the fuse functional circuit portion 800D via the base piece 830D. Therefore, it is possible to prevent the arc from being continuously generated between the divided cutting piece 420D and the base piece 430D.

As illustrated in FIG. 24, the fault current I2D induced to each fuse portion 850D causes the fusion portion 852D of each fuse portion 850D to generate heat and fuse. Further, the arc generated around the fusion portion 852D is quickly and effectively extinguished by the arc-extinguishing material QD filled around the fusion portion 852D.

As described above, according to the electrical circuit breaker device VD of the present invention, since the to-be-cut portion 400D and the fuse functional circuit portion 800D are connected before the state is broken in which the to-be-cut portion 400D is energized and the arc due to the fault current is generated between the base pieces 430D on both sides, the arc due to the fault current can be reliably induced to the fuse functional circuit portion 800D and extinguished by the fusion portion 852D and the arc-extinguishing material QD of the fuse functional circuit portion 800D, thereby preventing the overcurrent from flowing through the electrical circuit.

Next, as illustrated in FIG. 25, after the cutting piece 420D is cut off, the first moving body 500D continuously moves from the first end portion 320D to the second end portion 330D in the accommodating space 302D. Then, the first moving body 500D abuts on the upper end portion 610D side (the first end portion 320D side) of the second moving body 600D, and the first moving body 500D pushes out the second moving body 600D strongly toward the second end portion 330D side. Then, the lower end portion 650D of the second moving body 600D strongly abuts on the connection portion 810D of the fuse functional circuit portion 800D and pushes out the connection portion 810D toward the second end portion 330D side. Due to the pressing force, the connection portion 810D of the fuse functional circuit portion 800D is strongly pushed downward, and the element 851D of each fuse portion 850D coupled to both sides of the connection portion 810D is also strongly pulled downward. Then, the fusion portion 852D and a part of the element 851D are vertically divided, and the base pieces 830D on both sides are physically cut off. Note that in a case where the abnormal current is a relatively large current, as illustrated in FIG. 24, the fusion portion 852D is fused to break the electrical circuit. Here, as illustrated in FIG. 25, after the fusion portion 852D is fused and the electrical circuit is broken, the electrical circuit is physically and more reliably broken by cutting off the fusion portion 852D or a part of the element 851D. Note that the length between the cutting portions of the fuse portions 850D on both sides is L2D.

On the other hand, in a case where the abnormal current is a relatively low current, as illustrated in FIG. 24, when the cutting piece 420D is cut off, the fault current I2D flowing through the electrical circuit is induced to the fusion portion 852D of the fuse portions 850D on both sides via the base piece 830D. Therefore, it is possible to prevent generation of an arc between the divided cutting piece 420D and the base piece 430D.

However, in a case where the fault current I2D induced to each fusion portion 852D of the fuse functional circuit portion 800D belongs to a relatively low current range, there may be a case where each fusion portion 852D of the fuse functional circuit portion 800D is not fused and the current cannot be broken, or a case where it takes a relatively long time to break the current and the overcurrent flowing through the electrical circuit cannot be broken immediately.

However, as illustrated in FIG. 25, the second moving body 600D pushed out by the first moving body 500D cuts off the fusion portion 852D of the fuse functional circuit portion 800D. Therefore, in a case where the fusion portion 852D is not fused or it takes a relatively long time to break the current, it is still possible to immediately break the state that is energized via the fuse functional circuit portion 800D, so as to prevent an overcurrent from flowing through the electrical circuit. Further, in a case where an arc is generated around the fusion portion 852D when the fusion portion 852D is cut off, the arc is still effectively extinguished by the arc-extinguishing material QD around the fusion portion 852D.

As described above, according to the electrical circuit breaker device VD of the present invention, in a case where an overcurrent belonging to a relatively low current range flows through the electrical circuit, as illustrated in FIG. 24, the first moving body 500D cuts off the cutting piece 420D of the to-be-cut portion 400D, and then, as illustrated in FIG. 25, the second moving body 600D cuts off the fusion portion 852D of the fuse functional circuit portion 800D, thereby preventing the overcurrent from flowing through the electrical circuit. On the other hand, in a case where an overcurrent belonging to a relatively large current range flows through the electrical circuit, as illustrated in FIG. 24, when the first moving body 500D cuts off the cutting piece 420D of the to-be-cut portion 400D, a fault current is induced to the fusion portion 852D of the fuse functional circuit portion 800D to be safely broken, thereby preventing the overcurrent from flowing through the electrical circuit. Thus, according to the electrical circuit breaker device VD of the present invention, a quick breaking capability is provided for a wide current range, including not only relatively high currents, but also relatively low currents.

In the electrical circuit breaker device VD according to the present invention, as illustrated in FIGS. 24 and 25, the length L2D between the cutting portions of the fuse functional circuit portion 800D is shorter than the length L3D between the cutting portions CID of the cutting piece 420D and each of the base pieces 430D of the to-be-cut portion 400D. Further, the length L2D between the cutting portions of the fuse functional circuit portion 800D may be equal to the length L3D between the cutting portions CID of the cutting piece 420D and each of the base pieces 430D of the to-be-cut portion 400D. As described above, when the length L2D between the cutting portions of the fuse functional circuit portion 800D cut off by the second moving body 600D is equal to or less than the cutting length L3D when the cutting piece 420D is cut off by the first moving body 500D, that is, the relationship of length L2D≤length L3D is satisfied, the power of the first moving body 500D when the cutting piece 420D is cut off by the first moving body 500D is effectively transmitted in a manner of not being concentrated or attenuated to the cutting portion where the cutting distance of the second moving body 600D is short or equal, and a part (for example, the fusion portion 852D) of the fuse functional circuit portion 800D can be quickly and reliably cut off. Since the power of the power source PD can be efficiently transmitted, the power source PD can be reduced by decreasing the amount of gunpowder or the like, which contributes to the downsizing and lightweighting of the housing 301D.

In addition, in the electrical circuit breaker device VD of the present invention, as illustrated in FIG. 4, when the first moving body 500D cuts off the cutting piece 420D, the area of a portion is SID where the first moving body 500D comes into contact with the cutting piece 420D and applies a pressing force. As illustrated in FIG. 25, when the second moving body 600D cuts off each fusion portion 852D of the fuse functional circuit portion 800D, the sum of the area of the portion, where the fusion portion 852D is cut off, is the area S2D. The area S2C where the fusion portion 852D of the fuse functional circuit portion 800D is cut off by the second moving body 600D is smaller than the area S1D where the cutting piece 420D is cut off by the first moving body 500D. Alternatively, the area S2D where the fusion portion 852D of the fuse functional circuit portion 800D is cut off by the second moving body 600D may be equal to the area SID where the cutting piece 420D is cut off by the first moving body 500D. As described above, when the area S2D where the fusion portion 852D of the fuse functional circuit portion 800D is cut off by the second moving body 600D is equal to or smaller than the area S1D where the cutting piece 420D is cut off by the first moving body 500D, that is, the relationship of area S2D≤area S1D is satisfied, the power of the first moving body 500D when the cutting piece 420D is cut off by the first moving body 500D is effectively transmitted in a manner of not being concentrated or attenuated to the cutting portion where the cutting area of the second moving body 600D is small or equal, and the fusion portion 852D of the fuse functional circuit portion 800D can be quickly and reliably cut off. Since the power of the power source PD can be efficiently transmitted, the power source PD can be reduced by decreasing the amount of gunpowder or the like, which contributes to the downsizing and lightweighting of the housing 301D.

Note that the electrical circuit breaker device VD of the present invention is configured in such a manner that the relationship of length L2D≤length L3D and the relationship of area S2D≤area SID are simultaneously established, and the present invention is not limited thereto, and only one of the relationship of length L2D≤length L3D and the relationship of area S2D≤area SID may be established.

In the electrical circuit breaker device VD of the present invention, the two fuse portions 850D are connected in series, and the present invention is not limited thereto, and two fuse portions 850D may be connected in parallel. In the electrical circuit breaker device VD of the present invention, a total of two fuse portions 850D of the fuse functional circuit portion 800D are provided, and the present invention is not limited thereto, and three or more fuse portions 850D may be provided. By providing two or more fuse portions 850D, the breaking performance against a high current is improved. In the electrical circuit breaker device VD of the present invention, the fusion portion 852D of the fuse portion 850D of the fuse functional circuit portion 800D is cut off, and the present invention is not limited thereto. As long as the fuse functional circuit portion 800D can be broken, an arbitrary portion of the fuse functional circuit portion 800D may be cut off, for example, the connection portion 810D may be cut off instead of cutting off fusion portion 852D. In the electrical circuit breaker device VD of the present invention, the fuse portion 850D of the fuse functional circuit portion 800D is arranged below the to-be-cut portion 400D, and the present invention is not limited thereto. For example, when the fuse portion 850D is arranged in a manner of having the same height as that of the to-be-cut portion 400D (in the drawing, the fuse portion 850D is aligned in a staggered manner on the back side of the to-be-cut portion 400D), the height of the electrical circuit breaker device VD can be lowered.

### Sixth Embodiment

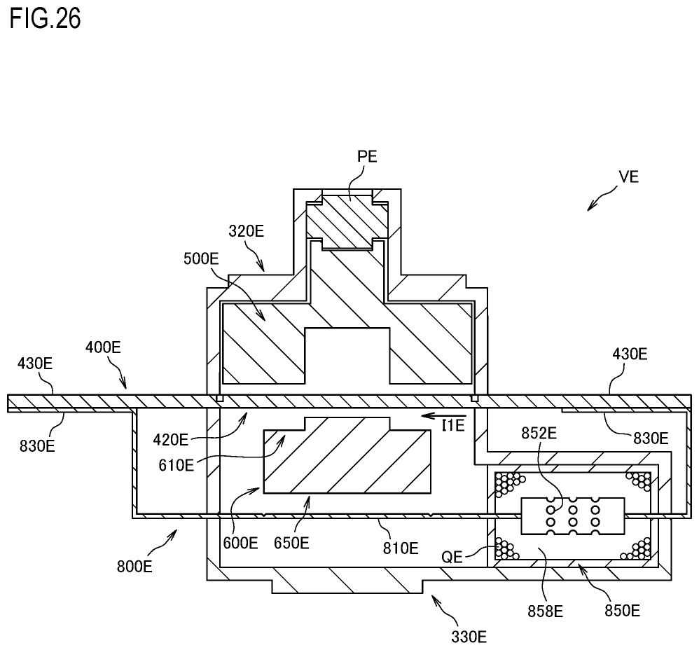

Next, an electrical circuit breaker device VE of the present invention according to the sixth embodiment will be described with reference to FIGS. 26 to 28. Further, the configuration of the electrical circuit breaker device VE according to the sixth embodiment is different from the configuration of the electrical circuit breaker device VC according to the fourth embodiment in the configuration of the fuse functional circuit portion 800D and the second moving body 600D. The other configurations are basically the same as the configuration of the electrical circuit breaker device VC according to the fourth embodiment, and thus the description of the same configurations is omitted. Note that similar to FIG. 20, FIG. 26 is a sectional view of the electrical circuit breaker device VE according to the sixth embodiment in an assembled state.

As illustrated in FIG. 26, the fuse functional circuit portion 800E basically has the same configuration as the fuse functional circuit portion 800C illustrated in FIG. 20, but differs in that the fuse functional circuit portion 800E does not include the deformable connection portion 820C. The second moving body 600E basically has the same configuration as the second moving body 600C illustrated in FIG. 20, but is configured in such a manner that the lower end portion 650E can push out the connection portion 810E of the fuse functional circuit portion 800E to be cut off. Since the connection portion 810E aligned in parallel with the cutting piece 420E is configured in a manner of being pushed downward by the second moving body 600E and cut off, it is not necessary to cut off the fusion portion 852C of the fuse portion 850C in a manner of pulling the fusion portion 852C vertically as illustrated in FIG. 20. Therefore, as illustrated in FIG. 26, the fuse portion 850E can be provided in a manner of being laid down in the horizontal direction, and the fusion portion 852E of the fuse functional circuit portion 800E can be arranged linearly (in other words, the fusion portion 852E is set to the same height as the connection portion 810E) with the connection portion 810E, and therefore the height of the entire electrical circuit breaker device VE including the fuse functional circuit portion 800E can be reduced.

The fuse portion 850E illustrated in FIG. 26 has the same configuration except that the fuse portion 850C illustrated in FIG. 20 is horizontally laid down. Since the accommodating space 858E of the fuse functional circuit portion 800E does not exist within the movement range of the first moving body 500E and the second moving body 600E, the arc-extinguishing material QE in the accommodating space 858E does not interfere with the first moving body 500E and the second moving body 600E, and does not hinder the movement of the first moving body 500E and the second moving body 600E.

Then, as illustrated in FIG. 26, the electrical circuit breaker device VE is used by being attached in an electrical circuit to be protected. Specifically, the base piece 430E of the to-be-cut portion 400E and the base piece 830E of the fuse functional circuit portion 800E are connected to a part of the electrical circuit, and the to-be-cut portion 400E and the fuse functional circuit portion 800E are connected in parallel so as to constitute a part of the electrical circuit. In the normal state (that is, when no abnormal current flows), since the base piece 430E and the cutting piece 420E of the to-be-cut portion 400E are not cut off and are physically and electrically connected, the current ILE flows through the electrical circuit via the base piece 430E and the cutting piece 420E of the to-be-cut portion 400E.

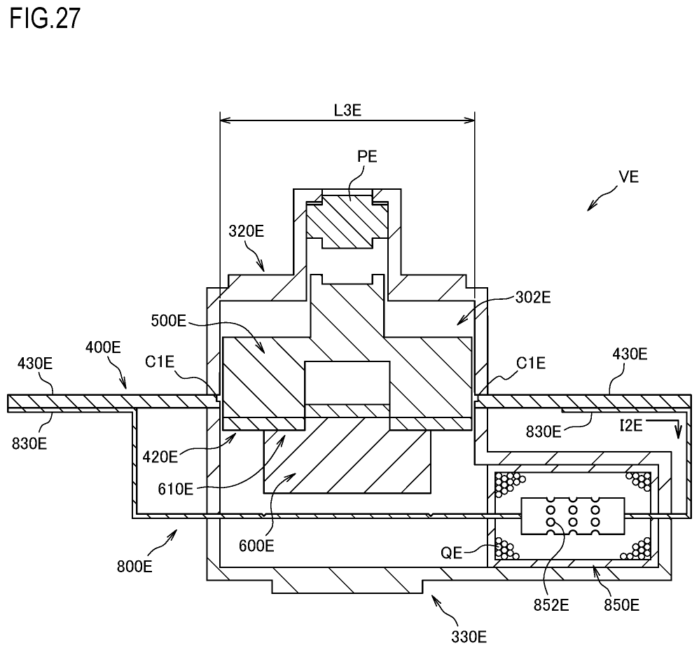

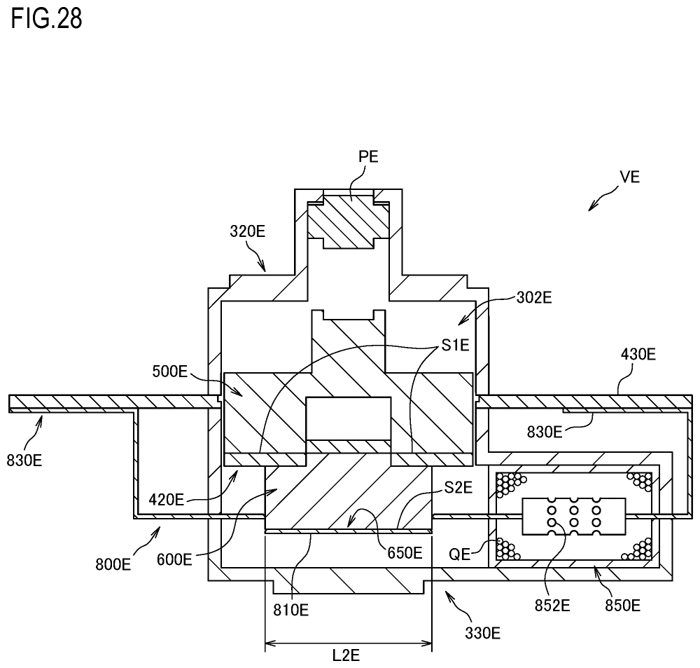

Next, a state in which the electrical circuit breaker device VE breaks the electrical circuit in a case where an abnormality such as overcurrent flowing through the electrical circuit is detected will be described with reference to FIGS. 27 and 28. Note that FIG. 27 is a sectional view illustrating a state in which the first moving body 500E moves from the state illustrated in FIG. 26, and FIG. 28 is a sectional view illustrating a state in which the first moving body 500E further moves from the state illustrated in FIG. 27.

First, as illustrated in FIG. 27, in a case where an abnormality such as overcurrent flowing through the electrical circuit is detected, an abnormal signal is input to the power source PE, and the gunpowder in the power source PE explodes. Then, by the air pressure, the first moving body 500E instantaneously moves in the accommodating space 302E toward the second end portion 330E, and strongly pushes the cutting piece 420E downward to divide the cutting piece 420E. Then, the state is broken in which the base pieces 430E on both sides of the to-be-cut portion 400E are energized via the cutting piece 420E, and an overcurrent can be prevented from flowing through the electrical circuit.

Here, in a case where the abnormal current is a relatively large current, after the cutting piece 420E is cut off, there is still a possibility that an arc continues to generate between the base pieces 430E and the cutting piece 420E which has been cut off. However, as illustrated in FIG. 27, since the base piece 430E of the to-be-cut portion 400E and the base piece 830E of the fuse functional circuit portion 800E are electrically connected before the cutting piece 420E of the to-be-cut portion 400E is cut off, when the cutting piece 420E is cut off, the fault current I2E flowing through the electrical circuit is induced to the fuse portion 850E of the fuse functional circuit portion 800E via the base piece 830E. Therefore, it is possible to prevent the arc from being continuously generated between the divided cutting piece 420E and the base piece 430E.

As illustrated in FIG. 27, the fault current I2E induced to the fuse portion 850E causes the fusion portion 852E of the fuse portion 850E to generate heat and fuse. Further, the arc generated around the fusion portion 852E is quickly and effectively extinguished by the arc-extinguishing material QE filled around the fusion portion 852E. As described above, in a case where the abnormal current is a relatively large current, the fault current is induced to the fusion portion 852E of the fuse functional circuit portion 800E to be safely broken, thereby preventing an overcurrent from flowing through the electrical circuit.

Next, as illustrated in FIG. 28, after the cutting piece 420E is cut off, the first moving body 500E continuously moves in the accommodating space 302E from the first end portion 320E to the second end portion 330E. Then, the first moving body 500E abuts on the second moving body 600E, and the first moving body 500E pushes out the second moving body 600E strongly toward the second end portion 330E side. Then, the lower end portion 650E of the second moving body 600E strongly abuts on the connection portion 810E of the fuse functional circuit portion 800E and pushes out the connection portion 810E toward the second end portion 330E side. Due to the pressing force, the connection portion 810E of the fuse functional circuit portion 800E is strongly pushed downward and cut off, and the base pieces 830E on both sides are physically cut off.

On the other hand, in a case where the abnormal current is a relatively low current, as illustrated in FIG. 27, when the cutting piece 420E is cut off, the fault current I2E flowing through the electrical circuit is induced to the fusion portion 852E of the fuse portion 850E via the base piece 830E. Therefore, it is possible to prevent generation of an arc between the divided cutting piece 420E and the base piece 430E.

However, in a case where the fault current I2E induced to the fusion portion 852E of the fuse functional circuit portion 800E belongs to a relatively low current range, there may be a case where the fusion portion 852E of the fuse functional circuit portion 800E is not fused and the current cannot be broken, or a case where it takes a relatively long time to break the current and the overcurrent flowing through the electrical circuit cannot be broken immediately.

However, as illustrated in FIG. 28 the second moving body 600E pushed out by the first moving body 500E cuts off the connection portion 810E of the fuse functional circuit portion 800E. Therefore, in a case where the fusion portion 852E is not fused or it takes a relatively long time to break the current, it is still possible to immediately break the state that is energized via the fuse functional circuit portion 800E, so as to prevent an overcurrent from flowing through the electrical circuit.

As described above, according to the electrical circuit breaker device VE of the present invention, in a case where an overcurrent belonging to a relatively low current range flows through the electrical circuit, as illustrated in FIG. 27, the first moving body 500E cuts off the cutting piece 420E of the to-be-cut portion 400E, and then, as illustrated in FIG. 28, the second moving body 600E cuts off the connection portion 810E of the fuse functional circuit portion 800E, thereby preventing the overcurrent from flowing through the electrical circuit. On the other hand, in a case where an overcurrent belonging to a relatively large current range flows through the electrical circuit, as illustrated in FIG. 27, when the first moving body 500E cuts off the cutting piece 420E of the to-be-cut portion 400E, a fault current is induced to the fusion portion 852E of the fuse functional circuit portion 800E to be safely broken, thereby preventing the overcurrent from flowing through the electrical circuit. Thus, according to the electrical circuit breaker device VE of the present invention, a quick breaking capability is provided for a wide current range, including not only relatively high currents, but also relatively low currents.

In the electrical circuit breaker device VE according to the present invention, as illustrated in FIGS. 27 and 28, the length L2E between the cutting portions of the connection portion 810E of the fuse functional circuit portion 800E is shorter than the length L3E between the cutting portions CIE of the cutting piece 420E and each of the base pieces 430E of the to-be-cut portion 400E. Further, the length L2E between the cutting portions of the connection portion 810E of the fuse functional circuit portion 800E may be equal to the length L3E between the cutting portions CIE of the cutting piece 420E and each of the base pieces 430E of the to-be-cut portion 400E. As described above, when the length L2E between the cutting portions of the connection portion 810E cut off by the second moving body 600E is equal to or less than the cutting length L3E when the cutting piece 420E is cut off by the first moving body 500E, that is, the relationship of length L2E≤length L3E is satisfied, the power of the first moving body 500E when the cutting piece 420E is cut off by the first moving body 500E is effectively transmitted in a manner of not being concentrated or attenuated to the second moving body 600E where the cutting length is short or equal, and the connection portion 810E of the fuse functional circuit portion 800E can be quickly and reliably cut off. Since the power of the power source PE can be efficiently transmitted, the power source PE can be reduced by decreasing the amount of gunpowder or the like, which contributes to the downsizing and lightweighting of the housing 301E.

In addition, in the electrical circuit breaker device VE of the present invention, as illustrated in FIG. 4, when the first moving body 500E cuts off the cutting piece 420E, the area of a portion is S1E where the first moving body 500E comes into contact with the cutting piece 420E and applies a pressing force. As illustrated in FIG. 28, when the second moving body 600E cuts off the connection portion 810E of the fuse functional circuit portion 800E, the area of the portion is S2E where the connection portion 810E is cut off. The area S2E where the connection portion 810E of the fuse functional circuit portion 800E is cut off by the second moving body 600E is smaller than the area S1E where the cutting piece 420E is cut off by the first moving body 500E. Alternatively, the area S2E where the connection portion 810E of the fuse functional circuit portion 800E is cut off by the second moving body 600E may be equal to the area S1E when the cutting piece 420E is cut off by the first moving body 500E. As described above, when the area S2E where the connection portion 810E of the fuse functional circuit portion 800E is cut off by the second moving body 600E is equal to or smaller than the area S1E where the cutting piece 420E is cut off by the first moving body 500E, that is, the relationship of area S2E≤area S1E is satisfied, the power of the first moving body 500E when the cutting piece 420E is cut off by the first moving body 500E is effectively transmitted in a manner of not being concentrated or attenuated to the cutting portion where the cutting area of the second moving body 600E is small or equal, and the connection portion 810E of the fuse functional circuit portion 800E can be quickly and reliably cut off. Since the power of the power source PE can be efficiently transmitted, the power source PE can be reduced by decreasing the amount of gunpowder or the like, which contributes to the downsizing and lightweighting of the housing 301E.

Note that the electrical circuit breaker device VE of the present invention is configured in such a manner that the relationship of length L2E≤length L3E and the relationship of area S2E≤area S1E are simultaneously established, and the present invention is not limited thereto, and only one of the relationship of length L2E≤ length L3E and the relationship of area S2E≤area S1E may be established. In the electrical circuit breaker device VE according to the present invention, the fuse portion 850E is laid down in the horizontal direction, and the present invention is not limited thereto, and the fuse portion 850E may be arranged in any position orientation, for example, upright in the vertical direction. The electrical circuit breaker device VE of the present invention includes one fuse portion 850E, and the present invention is not limited thereto, and two or more fuse portion 850E connected in parallel or in series may be included.

### Seventh Embodiment

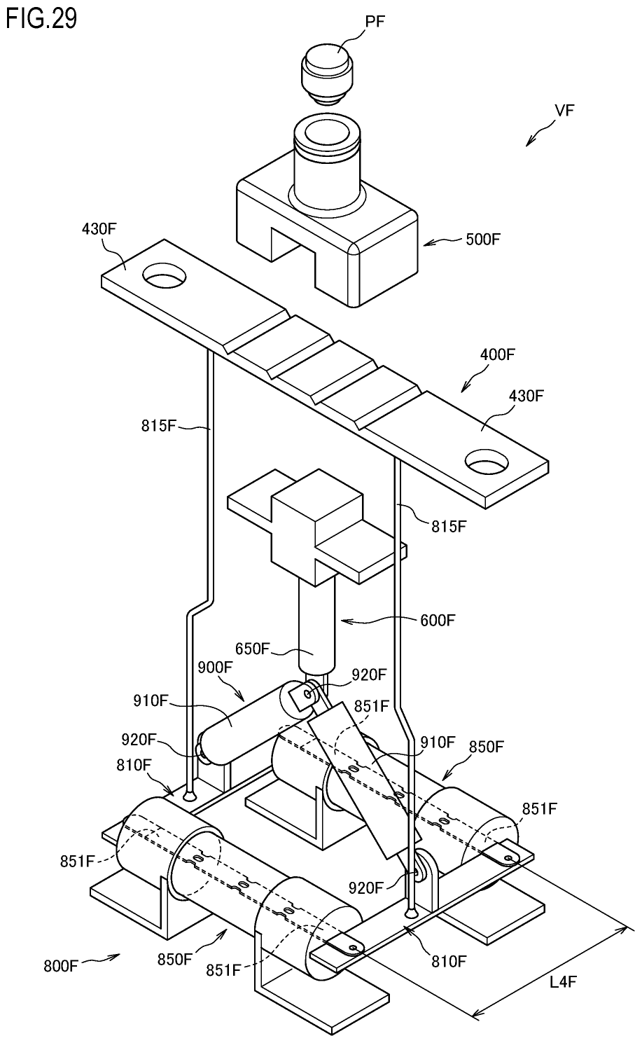

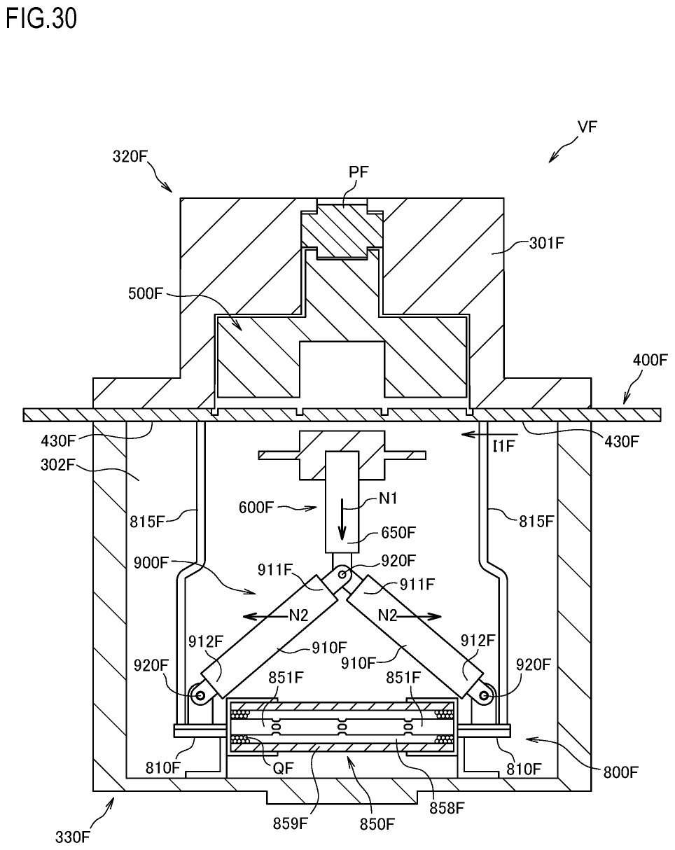

Next, an electrical circuit breaker device VF of the present invention according to the seventh embodiment will be described with reference to FIGS. 29 to 32. Further, the configuration of the electrical circuit breaker device VF according to the seventh embodiment is different from the configuration of the electrical circuit breaker device VC according to fourth embodiment in that the configuration of the fuse functional circuit portion 800F is different and that the conversion mechanism 900F is provided. The other configurations are basically the same as those of the electrical circuit breaker device VC according to the fourth embodiment, and thus the description of the same configurations is omitted. Note that FIG. 29 is a perspective view of a state in which the housing is removed to illustrate the internal structure of the electrical circuit breaker device VF, and FIG. 30 is a sectional view of the electrical circuit breaker device VF according to the seventh embodiment in an assembled state, similar to FIG. 20.

As illustrated in FIGS. 29 and 30, the fuse functional circuit portion 800F includes two fuse portions 850F and a connection portion 810F that electrically connects end portions on both sides of the two fuse portions 850F. The fuse portion 850F has the same configuration as the fuse portion 850C illustrated in FIG. 20. Since both ends of the element 851F of each fuse portion 850F are electrically and physically coupled to each connection portion 810F, two fuse portions 850F are connected in parallel to each other by the connection portions 810F on both sides. Each of the connection portions 810F is configured in a manner of being slidable in the extending direction of the element 851F of the fuse portion 850F, and each of the connection portions 810F is a metal conductor having rigidity enough not to be deformed by a force during sliding. Further, one connection portion 810F is electrically connected to one base piece 430F of the to-be-cut portion 400F by the connection member 815F such as an electric wire, and the other connection portion 810F is electrically connected to the other base piece 430F of the to-be-cut portion 400F by the connection member 815F such as an electric wire. Therefore, the fuse portion 850F of the fuse functional circuit portion 800F is connected in parallel to the base piece 430F of the to-be-cut portion 400F.

A conversion mechanism 900F is coupled to the lower end portion 650F side of the second moving body 600F. The conversion mechanism 900F includes two leg portions 910F, and distal ends 911F of the leg portions 910F on both sides are rotatably coupled to the lower end portion 650F of the second moving body 600F by a shaft member 920F. A terminal 912F of each leg portion 910F is also rotatably coupled to the connection portion 810F by the shaft member 920F. Therefore, when the second moving body 600F moves in a first direction N1 from the first end portion 320F toward the second end portion 330F, the leg portions 910F on both sides rotate in a manner of being open around the shaft member 920F of the distal end 911F, and move in a second direction N2 intersecting the first direction N1. As described in detail later, since the leg portions 910F on both sides move in the second direction N2 intersecting the first direction N1, each connection portion 810F connected to the leg portion 910F also move away from each other in the second direction N2. Therefore, the element 851F of the fuse portion 850F is pulled and cut off by the connection portion 810F on both sides.

As described above, in the electrical circuit breaker device VF illustrated in FIG. 30, it is not necessary to cut off the element 851C of the fuse portion 850C in a manner of pulling the element 851C up and down as illustrated in FIG. 20. Therefore, as illustrated in FIG. 30, since the fuse portion 850F can be arranged in a manner of being laid down in the horizontal direction, the height of the entire electrical circuit breaker device VF can be reduced by the amount of the laid fuse portion 850F. The accommodating space 302F in the housing 301F of the electrical circuit breaker device VF and the accommodating space 858F of the fuse portion 850F of the fuse functional circuit portion 800F are isolated from each other by the casing 859F of the fuse portion 850F, and the accommodating space 858F accommodating the arc-extinguishing material QF of the fuse functional circuit portion 800F and the accommodating space 302F accommodating the first moving body 500F and the second moving body 600F are separate spaces isolated from each other. That is, since the accommodating space 858F of the fuse functional circuit portion 800F does not exist within the movement range of the first moving body 500F and the second moving body 600F, the arc-extinguishing material QF in the accommodating space 858F does not interfere with the first moving body 500F and the second moving body 600F, and does not hinder the movement of the first moving body 500F and the second moving body 600F. Note that, in FIGS. 29 and 30, the conversion mechanism 900F is illustrated in a large size in order to facilitate understanding of the configuration of the conversion mechanism 900F.

Then, as illustrated in FIG. 30, the electrical circuit breaker device VF is used by being attached in an electrical circuit to be protected. Specifically, the base piece 430F of the to-be-cut portion 400F is connected to a part of the electrical circuit, and the to-be-cut portion 400F and the fuse functional circuit portion 800F are connected in parallel so as to constitute a part of the electrical circuit. In the normal state (that is, when no abnormal current flows), since the base piece 430F and the cutting piece 420F of the to-be-cut portion 400F are not cut off and are physically and electrically connected, the current I1F flows through the electrical circuit via the base piece 430F and the cutting piece 420F of the to-be-cut portion 400F.

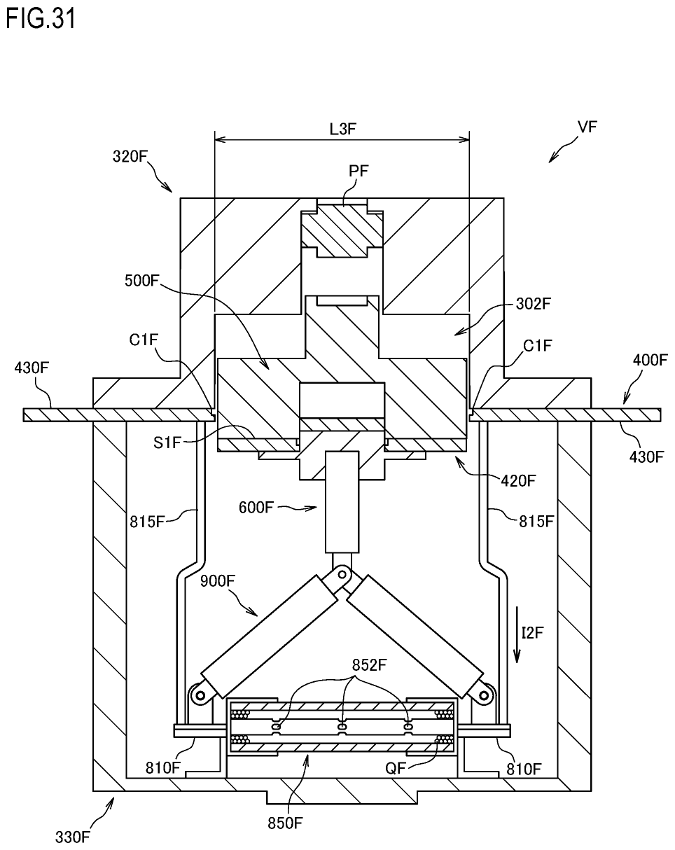

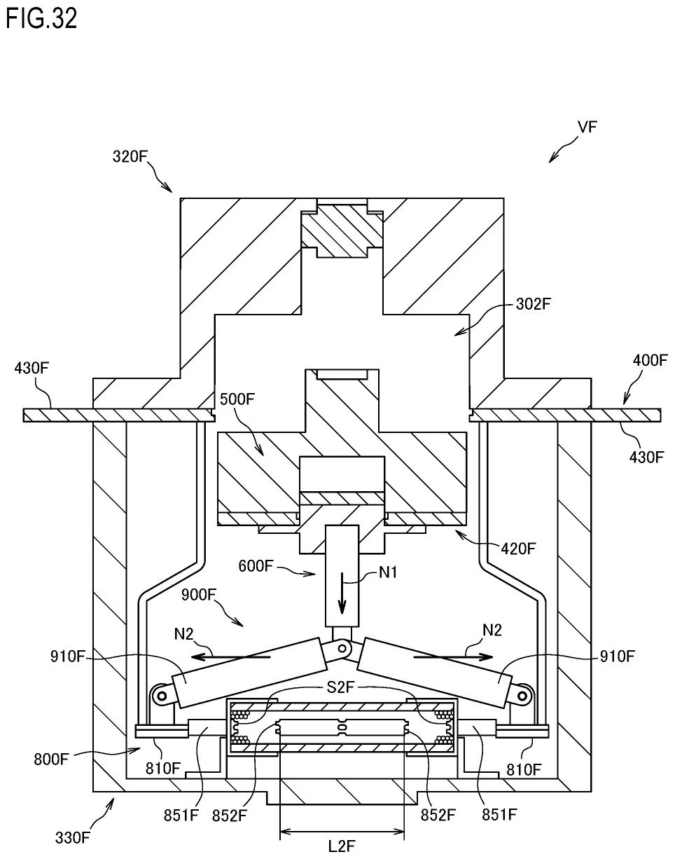

Next, a state in which the electrical circuit breaker device VF breaks the electrical circuit in a case where an abnormality such as overcurrent flowing through the electrical circuit is detected will be described with reference to FIGS. 31 and 32. Note that FIG. 31 is a sectional view illustrating a state in which the first moving body 500F moves from the state illustrated in FIG. 30, and FIG. 32 is a sectional view illustrating a state in which the first moving body 500F further moves from the state illustrated in FIG. 31.

First, as illustrated in FIG. 31, in a case where an abnormality such as overcurrent flowing through the electrical circuit is detected, an abnormal signal is input to the power source PF, and the gunpowder in the power source PF explodes. Then, by the air pressure, the first moving body 500F instantaneously moves in the accommodating space 302F toward the second end portion 330F, and strongly pushes the cutting piece 420F downward to divide the cutting piece 420F. Then, the state is broken in which the base pieces 430F on both sides of the to-be-cut portion 400F are energized via the cutting piece 420F, and an overcurrent can be prevented from flowing through the electrical circuit.

Here, in a case where the abnormal current is a relatively large current, after the cutting piece 420F is cut off, there is still a possibility that an arc continues to generate between the base pieces 430F and the cutting piece 420F which has been cut off. However, as illustrated in FIG. 31, since the base piece 430F of the to-be-cut portion 400F and the fuse portion 850F of the fuse functional circuit portion 800F are electrically connected by the connection member 815F before the cutting piece 420F of the to-be-cut portion 400F is cut off, when the cutting piece 420F is cut off, the fault current I2F flowing through the electrical circuit is induced to the fuse portion 850F via the connection member 815F. Therefore, it is possible to prevent the arc from being continuously generated between the divided cutting piece 420F and the base piece 430F.

As illustrated in FIG. 31, the fault current I2F induced to the fuse portion 850F causes the fusion portion 852F of the fuse portion 850F to generate heat and fuse. Further, the arc generated around the fusion portion 852F is quickly and effectively extinguished by the arc-extinguishing material QF filled around the fusion portion 852F. As described above, in a case where the abnormal current is a relatively large current, the fault current is induced to the fusion portion 852F of the fuse functional circuit portion 800F to be safely broken, thereby preventing an overcurrent from flowing through the electrical circuit.

Next, as illustrated in FIG. 32, after the cutting piece 420F is cut off, the first moving body 500F continuously moves in the accommodating space 302F from the first end portion 320F to the second end portion 330F. Then, the first moving body 500F strongly pushes the second moving body 600F toward the second end portion 330F side. When the second moving body 600F moves in the first direction N1 from the first end portion 320F toward the second end portion 330F, the leg portion 910F moves in the second direction N2 intersecting the first direction N1. Therefore, the connection portions 810F on both sides connected to each leg portion 910F move away from each other in the second direction N2. Then, the element 851F of the fuse portion 850F is pulled by the connection portions 810F on both sides and is divided near the fusion portion 852F. As described above, the conversion mechanism 900F converts the pressing force of the second moving body 600F in the first direction N1 into the tensile force in the second direction N2 to cut off a part of the fuse functional circuit portion 800F.

On the other hand, in a case where the abnormal current is a relatively low current, as illustrated in FIG. 31, when the cutting piece 420F is cut off, the fault current I2F flowing through the electrical circuit is induced to the fusion portion 852F of the fuse portion 850F. Therefore, it is possible to prevent generation of an arc between the divided cutting piece 420F and the base piece 430F.

However, in a case where the fault current I2F induced to the fusion portion 852F of the fuse functional circuit portion 800F belongs to a relatively low current range, there may be a case where the fusion portion 852F of the fuse functional circuit portion 800F is not fused and the current cannot be broken, or a case where it takes a relatively long time to break the current and the overcurrent flowing through the electrical circuit cannot be broken immediately.

However, as illustrated in FIG. 32, the conversion mechanism 900F receives the pressing force of the second moving body 600F pushed out by the first moving body 500F, and cuts off a part of the fuse functional circuit portion 800F. Therefore, in a case where the fusion portion 852F is not fused or it takes a relatively long time to break the current, it is still possible to immediately break the state that is energized via the fuse functional circuit portion 800F, so as to prevent an overcurrent from flowing through the electrical circuit.

As described above, according to the electrical circuit breaker device VF of the present invention, in a case where an overcurrent belonging to a relatively low current range flows through the electrical circuit, as illustrated in FIG. 31, the first moving body 500F cuts off the cutting piece 420F of the to-be-cut portion 400F, and then, as illustrated in FIG. 32, the conversion mechanism 900F receiving the pressing force of the second moving body 600F cuts off a part of the fuse functional circuit portion 800F, thereby preventing the overcurrent from flowing through the electrical circuit. On the other hand, in a case where an overcurrent belonging to a relatively large current range flows through the electrical circuit, as illustrated in FIG. 31, when the first moving body 500F cuts off the cutting piece 420F of the to-be-cut portion 400F, a fault current is induced to the fusion portion 852F of the fuse functional circuit portion 800F to be safely broken, thereby preventing the overcurrent from flowing through the electrical circuit. Thus, according to the electrical circuit breaker device VF of the present invention, a quick breaking capability is provided for a wide current range, including not only relatively high currents, but also relatively low currents.

In the electrical circuit breaker device VF according to the present invention, as illustrated in FIGS. 31 and 32, the length L2F between the cutting portions in the fuse portion 850F of the fuse functional circuit portion 800F is shorter than the length L3F between the cutting portions CIF of the cutting piece 420F and each of the base pieces 430F of the to-be-cut portion 400F. Further, the length L2F between the cutting portions in the fuse portion 850F of the fuse functional circuit portion 800F may be equal to the length L3F between the cutting portions CIF of the cutting piece 420F and each of the base pieces 430F of the to-be-cut portion 400F. As described above, when the length L2F between the cutting portions in the fuse portion 850F cut off by the conversion mechanism 900F receiving the pressing force of the second moving body 600F is equal to or less than the cutting length L3F when the cutting piece 420F is cut off by the first moving body 500F, that is, the relationship of length L2F≤length L3F is satisfied, the power of the first moving body 500F when the cutting piece 420F is cut off by the first moving body 500F is effectively transmitted in a manner of not being concentrated or attenuated to the conversion mechanism 900F where the cutting length is short or equal, and a part of the fuse functional circuit portion 800F can be quickly and reliably cut off. Since the power of the power source PF can be efficiently transmitted, the power source PF can be reduced by decreasing the amount of gunpowder or the like, which contributes to the downsizing and lightweighting of the housing 301F.

Similarly, in the electrical circuit breaker device VF according to the present invention, as illustrated in FIGS. 29 and 31, the length L4F between the cutting portions of the fuse portions 850F on both sides of the fuse functional circuit portion 800F is shorter than the length L3F between the cutting portions CIF of the cutting piece 420F and each of the base pieces 430F of the to-be-cut portion 400F. Further, the length L4F between the cutting portions of the fuse portions 850F on both sides of the fuse functional circuit portion 800F may be equal to the length L3F between the cutting portions CIF of the cutting piece 420F and each of the base pieces 430F of the to-be-cut portion 400F. As described above, when the length L4F between the cutting portions of the fuse portions 850F on both sides cut off by the conversion mechanism 900F receiving the pressing force of the second moving body 600F is equal to or less than the cutting length L3F when the cutting piece 420F is cut off by the first moving body 500F, that is, the relationship of length L4F≤length L3F is satisfied, the power of the first moving body 500F when the cutting piece 420F is cut off by the first moving body 500F is effectively transmitted in a manner of not being concentrated or attenuated to the conversion mechanism 900F where the cutting length is short or equal, and a part of the fuse functional circuit portion 800F can be quickly and reliably cut off. Since the power of the power source PF can be efficiently transmitted, the power source PF can be reduced by decreasing the amount of gunpowder or the like, which contributes to the downsizing and lightweighting of the housing 301F.

In addition, in the electrical circuit breaker device VF according to the present invention, as illustrated in FIG. 4, when the first moving body 500F cuts off the cutting piece 420F, the area of a portion is SIF where the first moving body 500F comes into contact with the cutting piece 420F and applies a pressing force. As illustrated in FIG. 32, the area of the portion, where the conversion mechanism 900F receiving the pressing force of the second moving body 600F cuts off a part of the fuse functional circuit portion 800F, is S2F. The area S2F where a part of the fuse functional circuit portion 800F is cut off by the conversion mechanism 900F is smaller than the area S1F where the cutting piece 420F is cut off by the first moving body 500F. Alternatively, the area S2F where a part of the fuse functional circuit portion 800F is cut off by the conversion mechanism 900F may be equal to the area SIF when the cutting piece 420F is cut off by the first moving body 500F. As described above, when the area S2F where a part of the fuse functional circuit portion 800F is cut off by the conversion mechanism 900F is equal to or smaller than the area SIF when the cutting piece 420F is cut off by the first moving body 500F, that is, the relationship of area S2F≤area S1F is satisfied, the power of the first moving body 500F when the cutting piece 420F is cut off by the first moving body 500F is effectively transmitted in a manner of not being concentrated or attenuated to the cutting portion where the cutting area of the conversion mechanism 900F receiving the pressing force of the second moving body 600F is small or equal, and a part of the fuse functional circuit portion 800F can be quickly and reliably cut off. Since the power of the power source PF can be efficiently transmitted, the power source PF can be reduced by decreasing the amount of gunpowder or the like, which contributes to the downsizing and lightweighting of the housing 301F.

The electrical circuit breaker device VF of the present invention is configured in such a manner that the relationship of length L2F≤length L3F, the relationship of L4F≤length L3F, and the relationship of area S2F≤area SIF are simultaneously established, and the present invention is not limited thereto, and only at least one of the relationship of length L2F≤length L3F, the relationship of L4F≤length L3F, and the relationship of area S2F≤area SIF may be established. In the electrical circuit breaker device VF of the present invention, a total of two fuse portions 850F of the fuse functional circuit portion 800F are provided, and the present invention is not limited thereto, and one or three or more fuse portion 850F may be provided. Further, the conversion mechanism 900F includes two leg portions 910F, and the present invention is not limited thereto, and the conversion mechanism 900F may have any configuration as long as the conversion mechanism 900F can convert the pressing force of the second moving body 600F in the first direction N1 into a tensile force in the second direction N2 to cut off a part of the fuse functional circuit portion 800F.

### Eighth Embodiment

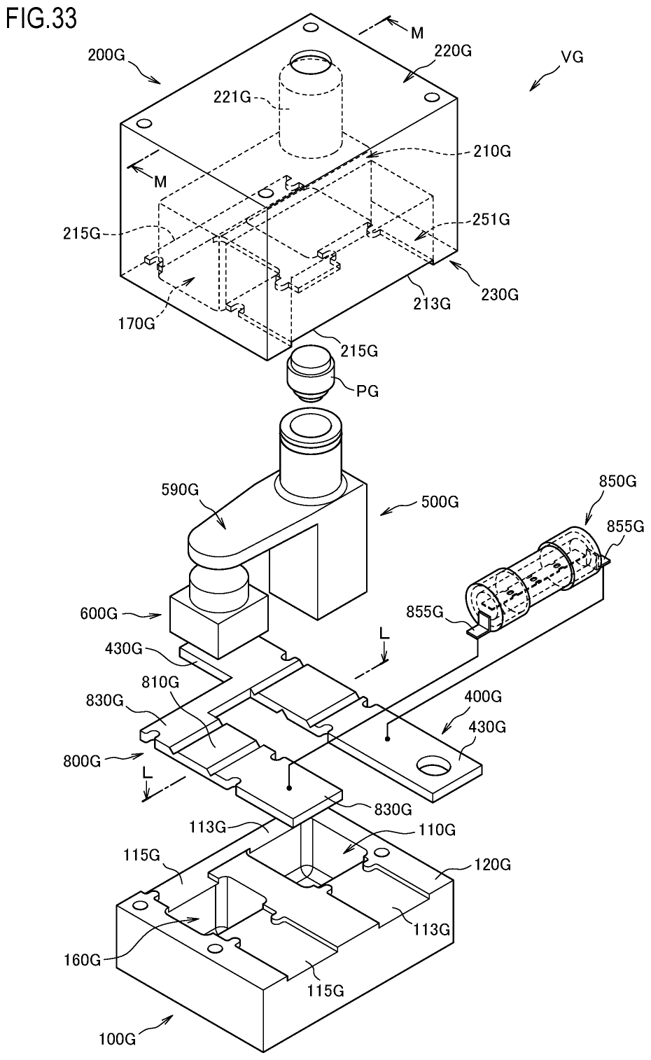

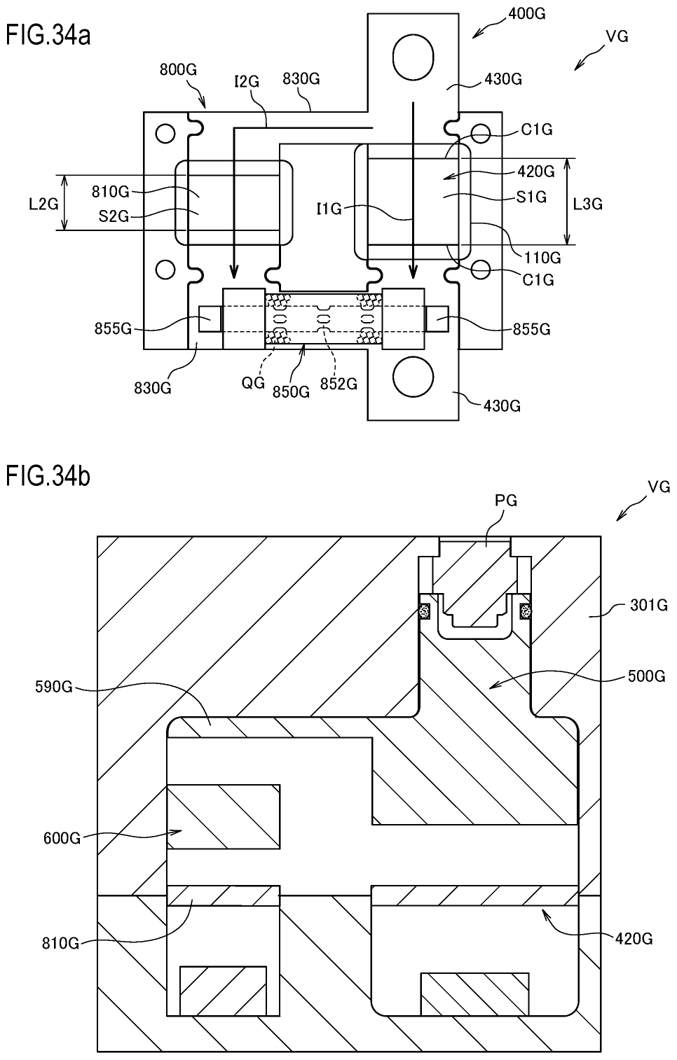

Next, an electrical circuit breaker device VG of the present invention according to the eighth embodiment will be described with reference to FIGS. 33 to 34. Further, the configuration of the electrical circuit breaker device VG of the present invention according to the eighth embodiment is basically the same as the configuration of the electrical circuit breaker device VC according to the fourth embodiment except mainly the configurations of the second moving body 600G and the fuse functional circuit portion 800G, and thus the description of the same configuration is omitted. FIG. 33 is an exploded overall perspective view illustrating the electrical circuit breaker device VG, FIG. 34(a) is a sectional view taken along line L-L in FIG. 33, and FIG. 34(b) is a sectional view taken along line M-M in FIG. 33.

As illustrated in FIGS. 33 and 34, the lower housing 100G is a substantially quadrangular prism body made of an insulator such as a synthetic resin, and has a lower accommodating portion 110G that is hollow inside. The lower accommodating portion 110G is configured to accommodate the first moving body 500G. In addition, the lower housing 100G includes, in a manner of being adjacent to the lower accommodating portion 110G, a lower accommodating portion 160G that is hollow inside. The lower accommodating portion 160G is configured to accommodate the second moving body 600G.

In addition, a placement portion 113G recessed in accordance with the shape of the base piece 430G is provided on a part of the upper surface 120G of the lower housing 100G in such a manner that the base piece 430G of the to-be-cut portion 400G can be placed. The placement portion 113G is arranged in a manner of facing both sides of the lower accommodating portion 110G, and the placement portion 113G supports the to-be-cut portion 400G, which linearly extends, on both sides.

The fuse functional circuit portion 800G is connected to the to-be-cut portion 400G in parallel on the same plane. The fuse functional circuit portion 800G is entirely made of a metal conductor such as copper in order to be electrically connected to the to-be-cut portion 400G. The fuse functional circuit portion 800G includes the base piece 830G directly coupled to one base piece 430G of the to-be-cut portion 400G, and the base piece 830G coupled to the other base piece 430G of the to-be-cut portion 400G via the fuse portion 850G. Further, the connection portion 810G positioned between the base pieces 830G on both sides is provided.

In addition, a placement portion 115G recessed in accordance with the shape of the base piece 830G is provided on a part of the upper surface 120G of the lower housing 100G in such a manner that the base piece 830G of the fuse functional circuit portion 800G can be placed. The placement portion 115G is arranged in a manner of facing both sides of the lower accommodating portion 160G, and the placement portion 115G supports the fuse functional circuit portion 800G, which linearly extends, on both sides.

The upper housing 200G is a substantially quadrangular prism body made of an insulator such as a synthetic resin, and constitutes the housing 301G together with the lower housing 100G as a pair. The upper housing 200G includes the upper accommodating portion 210G that is hollow inside, and the upper accommodating portion 210G is configured to accommodate the first moving body 500G. In addition, the upper housing 200G includes the upper accommodating portion 210G that is hollow inside adjacent to the upper accommodating portion 170G. The upper accommodating portion 170G is configured to accommodate the second moving body 600G.

In addition, the insertion portion 213G recessed in accordance with the shape of the base piece 430G is provided in a part of the lower surface 230G of the upper housing 200G in such a manner that the base piece 430G of the to-be-cut portion 400G can be inserted. The insertion portion 213G is arranged in a manner of facing both sides of the upper accommodating portion 210G, and is arranged at a position corresponding to the placement portion 113G of the lower housing 100G. In addition, an insertion portion 215G recessed in accordance with the shape of the base piece 830G is provided on a part of the lower surface 230G of the upper housing 200G in such a manner that the base piece 830G of the fuse functional circuit portion 800G can be arranged. The insertion portion 215G is arranged in a manner of facing both sides of the upper accommodating portion 170G, and the insertion portion 215G supports the fuse functional circuit portion 800G, which linearly extends, on both sides.

The fuse functional circuit portion 800G includes the fuse portion 850G, and the fuse portion 850G has the same configuration as the fuse portion 850C illustrated in FIG. 20. One terminal 855G of the fuse portion 850G is connected to the base piece 430G of the to-be-cut portion 400G, and the other terminal 855G of the fuse portion 850G is connected to the base piece 830G continuous with the connection portion 810G. Therefore, the fuse functional circuit portion 800G is connected in parallel to the to-be-cut portion 400G via the fuse portion 850G. The first moving body 500G includes a pressing portion 590G extending toward the upper end side of the second moving body 600G. The pressing portion 590G is configured to abut on the upper end side of the second moving body 600G to press the second moving body 600G downward.

As illustrated in FIG. 34, the electrical circuit breaker device VG is used by being attached in an electrical circuit to be protected. Specifically, the base piece 430G of the to-be-cut portion 400G is connected to a part of the electrical circuit, and the to-be-cut portion 400G constitutes a part of the electrical circuit. In the normal state, since the base piece 430G and the cutting piece 420G of the to-be-cut portion 400G are not cut off and are physically and electrically connected, the current I1G flows through the electrical circuit via the to-be-cut portion 400G.

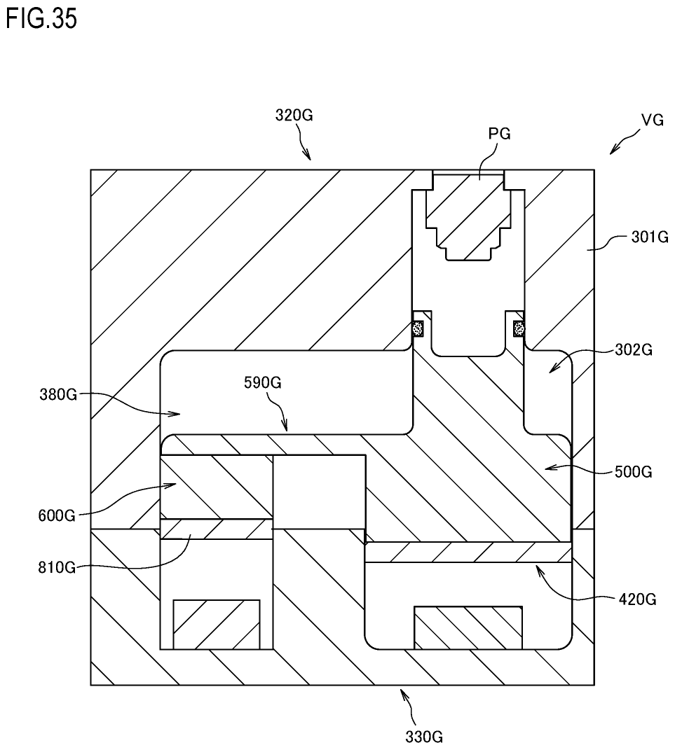

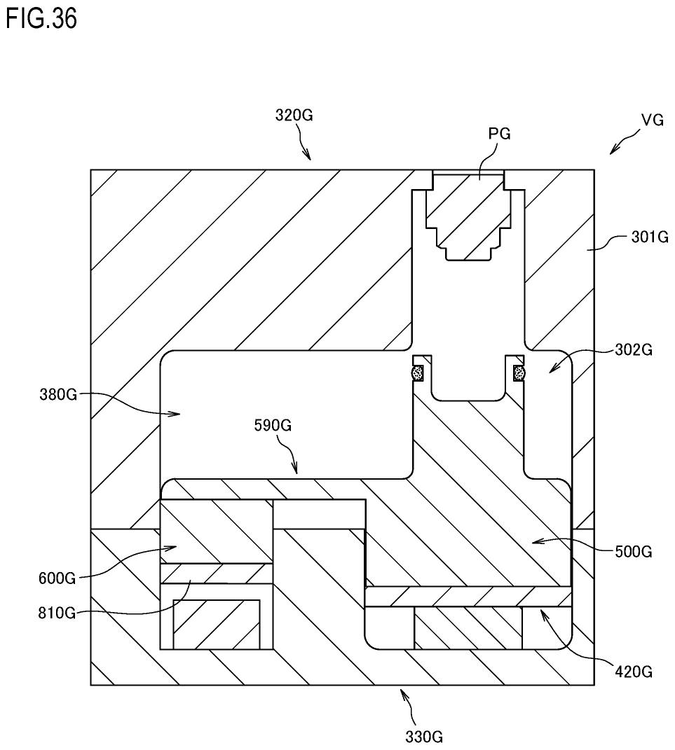

Next, a state in which the electrical circuit breaker device VG breaks the electrical circuit in a case where an abnormality such as overcurrent flowing through the electrical circuit is detected will be described with reference to FIGS. 35 and 36. Note that FIG. 35 is a sectional view illustrating a state in which the first moving body 500G moves from the state illustrated in FIG. 34(a), and FIG. 36 is a sectional view illustrating a state in which the first moving body 500G further moves from the state illustrated in FIG. 35.

First, as illustrated in FIG. 35, in a case where an abnormality such as overcurrent flowing through the electrical circuit is detected, an abnormal signal is input to the power source PG, and the gunpowder in the power source PG explodes. Then, by the air pressure, the first moving body 500G instantaneously moves in the accommodating space 302G toward the second end portion 330G, and strongly pushes the cutting piece 420G downward to divide the cutting piece 420G. Then, the state is broken in which the base pieces 430G on both sides of the to-be-cut portion 400G are energized via the cutting piece 420G, and an overcurrent can be prevented from flowing through the electrical circuit. Since the pressing portion 590G of the first moving body 500G moves toward the second end portion 330G, the second moving body 600G also moves in the accommodating portion 380G toward the second end portion 330G by being pressed by the pressing portion 590G. However, in the state illustrated in FIG. 35, the second moving body 600G does not cut off the connection portion 810G of the fuse functional circuit portion 800G. The accommodating portion 380G includes the upper accommodating portion 170G of the upper housing 200G and the lower accommodating portion 160G of the lower housing 100G.

Here, in a case where the abnormal current is a relatively large current, after the cutting piece 420G is cut off, there is still a possibility that an arc continues to generate between the base pieces 430G and the cutting piece 420G which has been cut off. However, as illustrated in FIG. 35, since the base piece 430G of the to-be-cut portion 400G and the fuse portion 850G of the fuse functional circuit portion 800G are electrically connected before the cutting piece 420G of the to-be-cut portion 400G is cut off, when the cutting piece 420G is cut off, as illustrated in FIG. 34(a), the fault current I2G flowing through the electrical circuit is induced to the fuse portion 850G of the fuse functional circuit portion 800G. Therefore, it is possible to prevent the arc from being continuously generated between the divided cutting piece 420G and the base piece 430G.

As illustrated in FIG. 34(a), the fault current I2G induced to the fuse portion 850G causes the fusion portion 852G of the fuse portion 850G to generate heat and fuse. Further, at the time of fusing the fusion portion 852G, an arc is generated around the fusion portion 852G by the voltage applied to the terminals 855G on both sides connected to the electrical circuit, but the arc is quickly and effectively extinguished by the arc-extinguishing material QG filled around the fusion portion 852G, and the electrical circuit is broken.

Next, as illustrated in FIG. 36, after the cutting piece 420G is cut off, the first moving body 500G continuously moves in the accommodating space 302G from the first end portion 320G to the second end portion 330G. Then, the pressing portion 590G of the first moving body 500G pushes out the second moving body 600G more strongly toward the second end portion 330G side. By the second moving body 600G receiving the pressing force, the connection portion 810G of the fuse functional circuit portion 800G is strongly pushed downward and cut off, and the base pieces 830G on both sides are physically cut off.

On the other hand, in a case where the abnormal current is a relatively low current, as illustrated in FIG. 35, when the cutting piece 420G is cut off, the fault current I2G flowing through the electrical circuit is induced to the fusion portion 852G of the fuse portion 850G of the fuse functional circuit portion 800G. Therefore, it is possible to prevent generation of an arc between the divided cutting piece 420G and the base piece 430G.

However, in a case where the fault current I2G induced to the fusion portion 852G of the fuse functional circuit portion 800G belongs to a relatively low current range, there may be a case where the fusion portion 852G of the fuse functional circuit portion 800G is not fused and the current cannot be broken, or a case where it takes a relatively long time to break the current and the overcurrent flowing through the electrical circuit cannot be broken immediately.

However, as illustrated in FIG. 36, the second moving body 600G pushed out by the pressing portion 590G of the first moving body 500G cuts off the connection portion 810G of the fuse functional circuit portion 800G. Therefore, in a case where the fusion portion 852G is not fused or it takes a relatively long time to break the current, it is still possible to immediately break the state that is energized via the fuse functional circuit portion 800G, so as to prevent an overcurrent from flowing through the electrical circuit.

As described above, according to the electrical circuit breaker device VG of the present invention, in a case where an overcurrent belonging to a relatively low current range flows through the electrical circuit, as illustrated in FIG. 35, the first moving body 500G cuts off the cutting piece 420G of the to-be-cut portion 400G, and then, as illustrated in FIG. 36, the second moving body 600G cuts off the connection portion 810G of the fuse functional circuit portion 800G, thereby preventing the overcurrent from flowing through the electrical circuit. On the other hand, in a case where an overcurrent belonging to a relatively large current range flows through the electrical circuit, as illustrated in FIG. 35, when the first moving body 500G cuts off the cutting piece 420G of the to-be-cut portion 400G, a fault current is induced to the fusion portion 852G of the fuse functional circuit portion 800G to be safely broken, thereby preventing the overcurrent from flowing through the electrical circuit. Thus, according to the electrical circuit breaker device VG of the present invention, a quick breaking capability is provided for a wide current range, including not only relatively high currents, but also relatively low currents.

In the electrical circuit breaker device VG according to the present invention, as illustrated in FIG. 34(a), the length L2G between the cutting portions of the connection portion 810G of the fuse functional circuit portion 800G is shorter than the length L3G between the cutting portions C1G of the cutting piece 420G and each of the base pieces 430G of the to-be-cut portion 400G. Further, the length L2G between the cutting portions of the connection portion 810G of the fuse functional circuit portion 800G may be equal to the length L3G between the cutting portions C1G of the cutting piece 420G and each of the base pieces 430G of the to-be-cut portion 400G. As described above, when the cutting length L2G of the connection portion 810G cut off by the second moving body 600G is equal to or less than the cutting length L3G when the cutting piece 420G is cut off by the first moving body 500G, that is, the relationship of length L2G≤length L3G is satisfied, the power of the first moving body 500G when the cutting piece 420G is cut off by the first moving body 500G is effectively transmitted in a manner of not being concentrated or attenuated to the second moving body 600G where the cutting length is short or equal, and the connection portion 810G of the fuse functional circuit portion 800G can be quickly and reliably cut off. Since the power of the power source PG can be efficiently transmitted, the power source PG can be reduced by decreasing the amount of gunpowder or the like, which contributes to the downsizing and lightweighting of the housing 301G.

In addition, in the electrical circuit breaker device VG of the present invention, as illustrated in FIG. 34(a), when the first moving body 500G cuts off the cutting piece 420G, the area of a portion is SIG where the first moving body 500G comes into contact with the cutting piece 420G and applies a pressing force. As illustrated in FIG. 34(a), when the second moving body 600G cuts off the connection portion 810G of the fuse functional circuit portion 800G, the area of the portion is S2G where the connection portion 810G is cut off. The area S2G where the connection portion 810G of the fuse functional circuit portion 800G is cut off by the second moving body 600G is smaller than the area SIG where the cutting piece 420G is cut off by the first moving body 500G. Alternatively, the area S2G where the connection portion 810G of the fuse functional circuit portion 800G is cut off by the second moving body 600G may be equal to the area SIG where the cutting piece 420G is cut off by the first moving body 500G. As described above, when the area S2G where the connection portion 810G of the fuse functional circuit portion 800G is cut off by the second moving body 600G is equal to or smaller than the area SIG where the cutting piece 420G is cut off by the first moving body 500G, that is, the relationship of area S2G≤area SIG is satisfied, the power of the first moving body 500G when the cutting piece 420G is cut off by the first moving body 500G is effectively transmitted in a manner of not being concentrated or attenuated to the cutting portion where the cutting area of the second moving body 600G is small or equal, and the connection portion 810G of the fuse functional circuit portion 800G can be quickly and reliably cut off. Since the power of the power source PG can be efficiently transmitted, the power source PG can be reduced by decreasing the amount of gunpowder or the like, which contributes to the downsizing and lightweighting of the housing 301G.

Note that the electrical circuit breaker device VG of the present invention is configured in such a manner that the relationship of length L2G≤length L3G and the relationship of area S2G≤area SIG are simultaneously established, and the present invention is not limited thereto, and only one of the relationship of length L2G≤ length L3G and the relationship of area S2G≤area S1G may be established. In addition, in the electrical circuit breaker device VG of the present invention, since the to-be-cut portion 400G and the fuse functional circuit portion 800G are arranged side by side, the height of the electrical circuit breaker device VG can be reduced as compared with the case where the to-be-cut portion 400G and the fuse functional circuit portion 800G are arranged in the vertical direction (see, for example, FIG. 20).

In addition, the electrical circuit breaker device of the present invention is not limited to the above embodiments, and various modifications and combinations are possible within the scope of the claims and the scope of the embodiments, and these modifications and combinations are also included in the scope of the claims.

1. An electrical circuit breaker device comprising:
a housing;
a to-be-cut portion that is arranged in the housing and constitutes a part of an electrical circuit;
a power source that is arranged on a side of a first end portion of the housing; and
a moving body that moves in the housing between the first end portion and a second end portion on an opposite side of the first end portion by the power source, wherein
the electrical circuit breaker device includes a fuse functional circuit portion that is connected to the to-be-cut portion and has a fusion portion and an arc-extinguishing material,
the moving body includes a first moving body that moves by the power source, and a second moving body that moves by a power of the first moving body,
the first moving body moves from the first end portion toward the second end portion by the power source, and cuts off a cutting piece positioned between base pieces on both sides of the to-be-cut portion, and
the second moving body cuts off a part of the fuse functional circuit portion after the first moving body cuts off the cutting piece.

2. The electrical circuit breaker device according to claim 1, wherein
an accommodating space in which the arc-extinguishing material of the fuse functional circuit portion is accommodated is a space different from an accommodating space in which the first moving body and the second moving body are movably accommodated,
the fuse functional circuit portion includes a deformable connection portion that connects the fusion portion and the to-be-cut portion and is deformable, and
the second moving body pushes out a part of the fuse functional circuit portion to cut off the fusion portion and deform the deformable connection portion.

3. The electrical circuit breaker device according to claim 1, wherein
the accommodating space in which the arc-extinguishing material of the fuse functional circuit portion is accommodated is the space different from an accommodating space in which the first moving body and the second moving body are movably accommodated,
the fuse functional circuit portion includes at least two fusion portions, and
the second moving body pushes out a part of the fuse functional circuit portion to break the fuse functional circuit portion.

4. The electrical circuit breaker device according to claim 1, wherein
the second moving body includes an accommodating space through which a part of the fuse functional circuit portion is inserted and in which the arc-extinguishing material can be accommodated, and
the second moving body moves to apply a pressing force to a part of the fuse functional circuit portion through the arc-extinguishing material to cut off the part of the fuse functional circuit portion.

5. The electrical circuit breaker device according to claim 1, wherein
a length between cutting portions on both sides of the fuse functional circuit portion is shorter than a length between cutting portions of a cutting piece and base pieces on both sides of the to-be-cut portion, or a length between cutting portions on both sides of the fuse functional circuit portion is equal to a length between cutting portions of a cutting piece and base pieces on both sides of the to-be-cut portion.

6. The electrical circuit breaker device according to claim 1 further comprising
a conversion mechanism that converts a pressing force for moving the second moving body in a first direction from the first end portion to the second end portion into a tensile force in a second direction intersecting the first direction, wherein
the tensile force cuts off a part of the fuse functional circuit portion.
